(19) United States
(12) Patent Application Publication
(10) Pub. No.: US 2013/0041775 A1
(43) Pub. Date: Feb. 14, 2013

(54) System and Apparatus for Enabling Access to Business Service

(71) Applicant: Einar Rosenberg, Miami, FL (US)

(72) Inventor: Einar Rosenberg, Miami, FL (US)

(21) Appl. No.: 13/569,964

(22) Filed: Aug. 8, 2012

Related U.S. Application Data
(60) Provisional application No. 61/521,319, filed on Aug. 8, 2011.

(51) Int. Cl. G06Q 30/00; H04B 5/00

(52) U.S. Cl. 705/26.9; 705/26.1

(57) ABSTRACT

A near field communications enabled mobile communication with the appropriate program is used to provide or receive information related to service provided to or for a customer. Using the mobile communication device increases the customer's access to service and service personnel.

### CROSS REFERENCE TO RELATED APPLICATIONS

The present application claims benefit to U.S. Patent Application Ser. No. 61/521,319, filed on Aug. 8, 2011, the disclosure of which is incorporated by reference in its entirety.

### FIELD OF THE INVENTION

The present invention relates to wireless electronic data transfer and more specifically to the use of near field communications for secure wireless information transactions.

### BACKGROUND OF THE INVENTION

A Smartcard communicates to Smartcard reader, or a Near Field Communications (“NFC”) reader, the type of risk management checks that the card issuer wants to be performed, such as the floor limit, random online processing, and a velocity check, that determines whether an on-line authorization is necessary. Next, a point of sale (“POS”) terminal requests authorization via the back-end processing network that connects to the seller's financial institution, home office, or bank (if necessary), just like magnetic stripe card. Upon approval, the NFC reader and the smart chip may exchange additional information such as reward points or e-coupons for the next purchase. This information is then stored on the smart chip for future use, or could be used for the current transaction.

In contactless, or wireless, Smartcard applications, information contained on the Smartcard is transferred in one direction. Information is provided to the NFC reader when the Smartcard is placed in close proximity to the NFC reader. For example, a Mobil Speedpass smartcard is waved near a gas pump (containing a reader) to permit the customer to purchase gasoline from the pump. When the Speedpass is placed near the gas pump, the customer's account information is wirelessly provided to a reader in the gas pump. The account information is then used for approval of and billing of a gasoline purchase that will follow.

In some applications, information is transferred between the Smartcard and the NFC reader. For example, commuters may use a Smartcard to pay for subway or bus transit, where fares are conventionally paid at the beginning or conclusion of the metro transit. The Smartcard stores an “electronic cash” value on the card. When entering the metro the Smartcard is placed near the NFC reader on a turnstile and the reader receives payment information from the Smartcard. The customer provides no additional information to the Smartcard or NFC reader, and does not take any further action affirming the transaction. If the Smartcard has at least a predetermined amount of electronic cash, then the smart reader provides a signal to the Smartcard indicating the metro entry point and provides a signal to the turnstile, permitting the customer to enter. If there are not sufficient electronic funds, then the NFC reader does not provide a signal to the turnstile, and therefore the customer is not permitted to enter. To exit the metro at the end of the transit, the customer places the Smartcard near the NFC reader of a turnstile. The NFC reader determines the fare (by reading the entry point from the Smartcard), and deducts the fare from the value of the electronic cash stored on the card. The NFC reader provides a signal to the turnstile permitting the customer to exit.

As described above, a contactless Smartcard can be used for information transactions (e.g., subway or bus fare transit). However, there is little to ensure that the person using the contactless Smartcard is the same person who owns the Smartcard. As Smartcards are typically pre-programmed to operate in a contactless mode, the information on a smartcard is available to be read by any device capable of reading smartcards, For example, a valid subway card or Speedpass may be used by anyone in possession of the transit card/Speedpass, respectively, even though the possessor of the transit card/Speedpass may not be the owner of the transit card/Speedpass.

In other situations, individuals come to experience many service oriented situations, for example, from coffee shops to banks to restaurants to gas stations. In each of the situations, an individual desires service from the business, and thus either waits in a queue to be served or has been served and requires additional service. In former case, it would be desirable that a customer can be made aware of his current status in the queue without having to maintain a position close to the service area. It would also be desirable for the customer to be able to exercise some control over his position in the queue and be able to delay his position in the position. With respect to the latter, it would be desirable for customer in a service establishment to be able to send a request for service without having to relocate or without having to find a service person. It would also be desirable to be able to communicate some information to the service person or provider regarding the nature of the customer's request for service.

It would also be desirable to be able to remotely order service and that service request be directed to the appropriate closest service provider.

### BRIEF DESCRIPTION OF THE DRAWINGS

FIG. 1 depicts the use of a near field communication device to perform communications with a business according to an exemplary embodiment;

FIG. 2 depicts a customer-business communication system according to an exemplary embodiment;

FIG. 3 depicts a customer-business communication system according to an exemplary embodiment;

FIG. 4 depicts an exemplary NFC tag data packet contained in an NFC tag according to an exemplary embodiment;

FIG. 5 depicts an exemplary MCD data packet according to an exemplary embodiment;

FIG. 6 depicts a NFC tag lookup database according to an exemplary embodiment;

FIG. 7 depicts a NFC tag-Employee lookup database according to an exemplary embodiment;

FIG. 8 depicts an Employee lookup database according to an exemplary embodiment;

FIG. 9 depicts an exemplar process flow of a program on a MCD used in conjunction with a customer-business communication system according to an exemplary embodiment;

FIG. 10 depicts an exemplar process flow of a program on a business computer system used in conjunction with a customer-business communication system according to an exemplary embodiment;

FIG. 11 depicts a NFC tag-Employee lookup database according to another exemplary embodiment;

FIG. 12 depicts an Employee lookup database according to another exemplary embodiment;

FIG. 13 depicts an exemplar process flow of a program on a MCD used in conjunction with a customer-business communication system according to another exemplary embodiment;

FIG. 14 depicts an exemplar process flow of a program on a business computer system used in conjunction with a customer-business communication system according to another exemplary embodiment;

FIG. 15 depicts a representation of a customer-business communication system according to yet an exemplary embodiment;

FIG. 16 depicts a customer-business communication system according to yet an exemplary embodiment;

FIG. 17 depicts a representation of a NFC tag data;

FIG. 18 depicts a representation of a closest business lookup database;

FIG. 19 depicts an exemplar process flow of a program on a MCD used in conjunction with a customer-business communication system;

FIG. 20 depicts an exemplar process flow of a program on a business computer system used in conjunction with a customer-business communication system;

FIG. 21 depicts a representation of a Queue lookup database;

FIG. 22 depicts another exemplar process flow of a program on a MCD used in conjunction with a customer-business communication system;

FIG. 23 depicts another exemplar process flow of a program on a business computer system used in conjunction with a customer-business communication system;

FIG. 24 depicts yet another exemplar process flow of a program on a MCD used in conjunction with a customer-business communication system; and

FIG. 25 depicts yet another exemplar process flow of a program on a business computer system used in conjunction with a customer-business communication system.

### DETAILED DESCRIPTION OF THE INVENTION

In the following detailed description, reference is made to the accompanying drawings, which form a part hereof, and in which is shown by way of illustration specific exemplary embodiments of the invention. These embodiments are described in sufficient detail to enable those of ordinary skill in the art to make and use the invention, and it is to be understood that structural, logical, or other changes may be made to the specific embodiments disclosed without departing from the spirit and scope of the present invention.

Although not intended to be limiting, a “Smartlink” (Smartlink defines near field communications capable devices and the ecosystem and infrastructure the NFC enabled device interacts with) system in a preferred embodiment is a system that includes a Smartlink server and Smartlink capable device. A Smartlink server is a computer or processing system that maintains information about customers of Smartlink capable devices. This information may include a customer's account information, device information, and the like. The Smartlink server is capable of communicating with a customer's Smartlink capable device through cellular communications as is conventionally known. The Smartlink server is capable of communicating with other computer servers (of seller's, banks, and other institutions) through conventional means. A Smartlink capable device can be any such embodiment or aspect described below.

The present invention provides methods and apparatus for wireless transactions with increased security as well as near field communication transactions using mobile communication devices. In exemplary embodiments, a mobile communication device facilitates information and service delivery and various applications are provided using the methods to perform electronic transactions using near field communications. In a preferred approach, a customer or another appropriate person has downloaded an appropriate application, e.g., a mobile communication device contact software application, to the mobile communication device to execute the appropriate commands to interact with the environment, e.g., the store or service provider. For example, a Sears MCD contact software for use in a Sears store, or a Hooter's MCD contact software for use in a Hooter's restaurant.

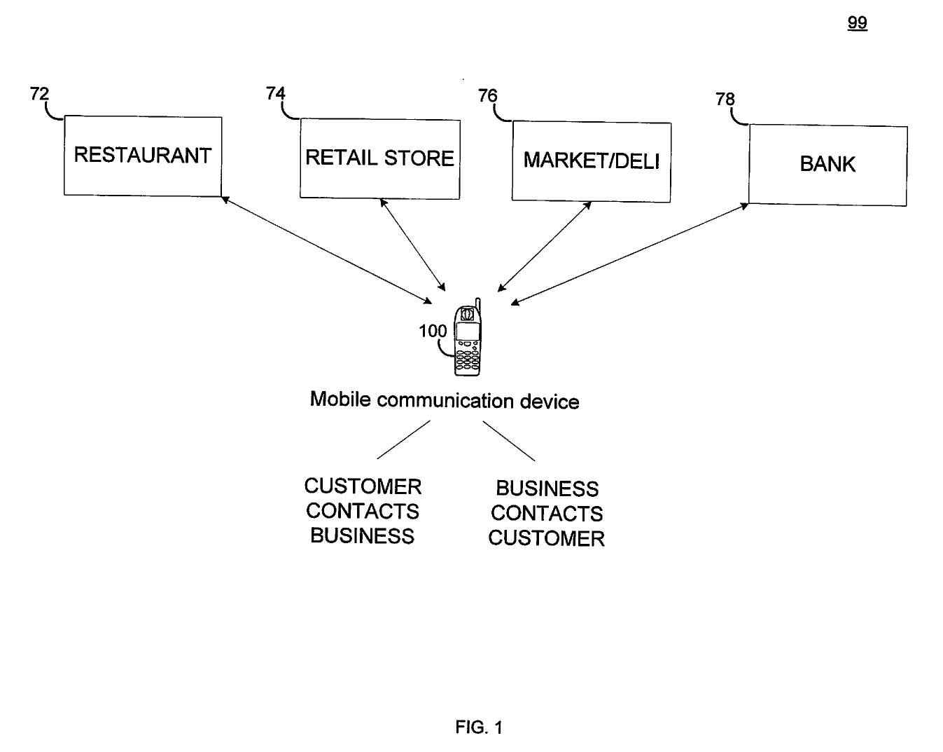

In an exemplary aspect of the invention, a mobile communications device (“MCD”) is used to communicate with business, as depicted, for example in FIGS. 1-3. As depicted in the example of FIG. 1, a MCD is used to communicate with different businesses, a restaurant 72, a retail store 74, and market/deli 76, and a bank 78. A MCD preferably is a smart type of cellular phone that includes cellular communication and data communication systems, thereby enabling phone communications, SMS/MMS communications, email communications, and the ability to access and search the Internet. Current examples of smart phones include the Apple iPhones, Samsung Galaxy, Palm Pre, and HTC Evo. In an exemplary use, a near field communications enabled mobile communications device, e.g., MCD 100, reads information, preferably, from an NFC tag or some other source of appropriate information that provides the information necessary to communicate with a person or thing. Current examples of smart phones that include NFC are Blackberry Bold 9790, Samsung Galaxy Nexus, and the Motorola MC75A.

For example, the mobile communications device when placed within range of an NFC tag, reads the NFC tag at a particular location and receives information from the NFC tag representing, directly or indirectly, the contact information, e.g., a phone number, of a business employee, e.g., a person, desired to be communicated with. This information is stored in the mobile communications device, and used, automatically by a program on the MCD 100 or when initiated by the customer on the mobile communication device, to communicate with a person/business preferably by an application of a program residing and operating on the mobile communication device 100. Additionally, the mobile communication device 100 provides additional information to the person being communicated with, including, but not limited to, a location to respond to and/or contact information for the customer using the MCD 100. Ideally, a NFC tag is placed in a prominent and/or obvious location.

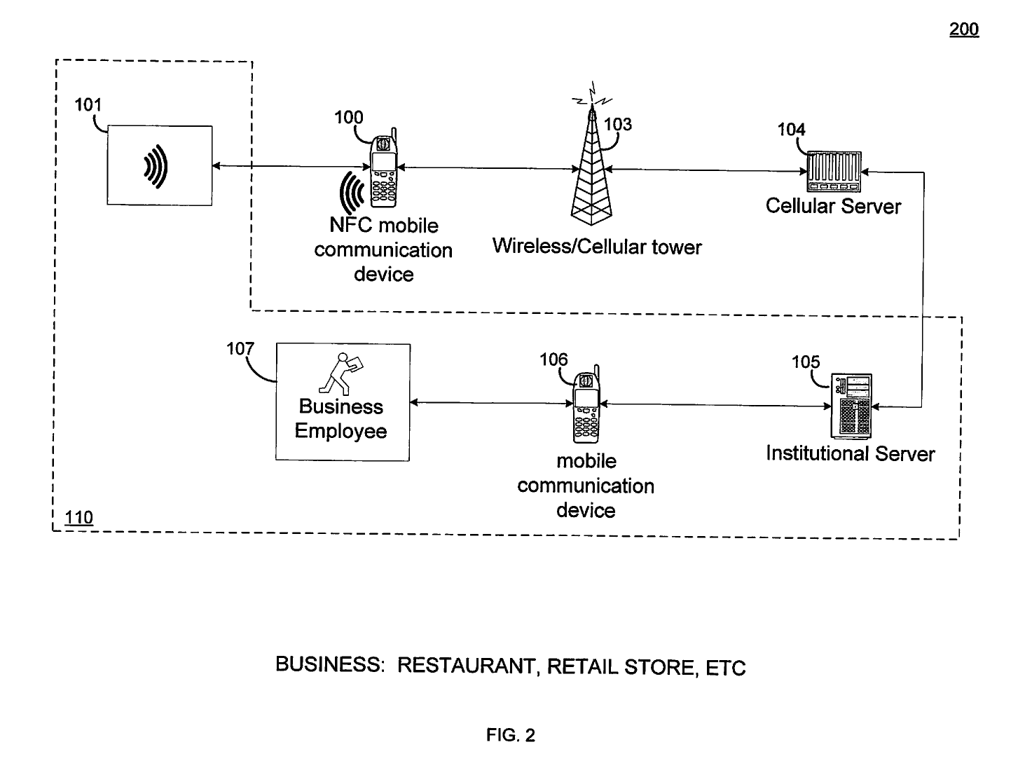

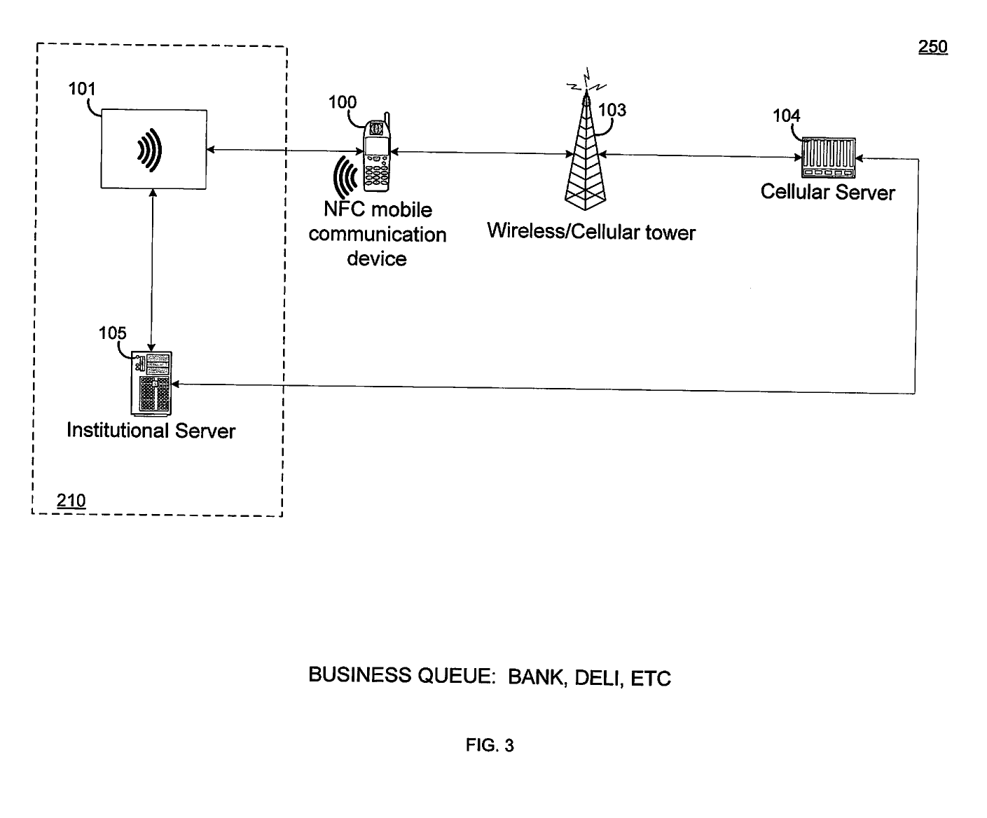

FIG. 2 represents business scenarios 200 where a customer desires to contact a business employee and have them respond to the location of the customer. These scenarios include, for example, retail stores and restaurants. FIG. 3 represents business scenarios 250 where a customer desires to be place in or manage his place in a business queue for service. These scenarios include, for example, markets, deli counters, and banks.

For example in FIG. 2, in a store or restaurant, a customer-business communication system—an employee “paging” system—is used to request assistance from a business employee. The exemplary customer-business communication system 200 includes an NFC tag 101, a MCD having near field communications capabilities 100, a wireless tower 103, a cellular server 104, an institutional server 105, a mobile communication device 106, and an employee 107.

The mobile communication device 102 communicates through its cellular tower system 103 to its cellular server 104. The cellular server 104 communicates with the business server 105 of a business 110 which determines an appropriate employee and then the business computer system communicates with the communication device 106 of the employee 107.

An NFC tag 101 at a specified location in a business 110 is read by a mobile communication device 100. The mobile communication device 100 executes an appropriate program and provides its customer an option to communicate to/with—“page”—a business employee. If the customer accepts the option, the mobile communication device 100, using the information acquired and interpreted from the NFC tag 101, e.g., the business and specific location in that business 110 where the consumer is located and information and therefore the location of the NFC tag 101, establishes communications with an institutional server 105, or business computer system, associated with the business 110, will send the customer's location information to the server associated via the wireless or Internet data connection of the mobile communication device. The server 105, based on the information received from the mobile communication device, will understand the location of the customer requesting a page. The server 105 will then provide that information to the business at that location of the customer so that the business can, in turn, notify an employee where a customer is requesting assistance. In another aspect, the server accesses business records associated with the business where the customer is located, and determines what employees are currently working. Having determined what employees are working and which, if any, employee corresponds to the NFC tag 101, the server 105 provides a communication to a designated employee via her SMS, MMS, mobile communication device, or other communication means. The employee 107 then is directed to the customer at the specified location in the business 110.

In greater detailed example of an employee communications system 200, as depicted in FIG. 2, for example, includes an MCD 100 that has installed a MCD contact software application, e.g., an “app,” for appropriate operations. An application can be downloaded from an appropriate source, e.g., CNET, Apple App store, Samsung App store, business website, etc., as is commonly understood. After downloading, the application is then installed, preferably, the application self installs on the customer's MCD 100 after downloading. In other aspects, the application is installed manually by a customer or other third party. After successful installation, the software is ready to be activated.

In another approach, the native capability of a MCD is used to download and install an application. NFC tags can be programmed or encoded with many things including specific instructions or a web address. For example, a MCD with NFC capabilities is placed near an NFC tag. The native capability of MCD reads information from the NFC tag. In the exemplary approach, the NFC tag has instructions which indicates that in that context a particular application is to be used. The MCD examines its apps to determine whether or not the app is already installed on the MCD. If the MCD does not already have the app installed, the MCD uses information from the NFC tag which provides instructions of where to download the app from. After the app is downloaded to the MCD, instructions from the NFC tag cause the MCD to install the app. If app is installed, then native intelligence of the MCD will automatically lock into this app.

Apps occasionally need to be updated. There two common ways in which this can be done: 1) if the app was previously downloaded from an app store, then the app store should inform the MCD's customer when a new update is available. Depending on settings, updates can be downloaded and installed automatically or only after manual confirmation to update system. 2) When the app on a MCD communicates with its server, the server will, generally as soon it hits, indicate that an update is available. The server either allows manually downloading and installing the update or it forces the MCD to download and install the update.

Generally, a MCD contact software application is specific to a context. For example, a Home Depot app would be used as MCD contact software in a Home Depot store and a Sears app would be used as MCD contact software in a Sears store. Thus, different MCD contact software is used in each different context. For example, Sears MDC contact software generally would not be used in the context of Home Depot store for operations involving Home Depot.

In certain operating systems, the MCD contact application executes as a background application until it is triggered, either manually or automatically in response to a signal received. For example in an automated approach, the MCD contact application runs in a background mode until it receives a signal, where the signal is a specific radio signal, or one of a plurality of signals, received by the MCD 100. The MCD 100 radio operations are monitored by the MCD contact application and when it identifies a signal received that is an identified signal or one of a plurality of signals, then the MCD contact application sends an appropriate signal to the operating system to make the MCD contact application to be a foreground application. For example, as noted above, when a MCD receives a signal from an NFC tag, the MCD checks to see if the appropriate application is installed. If the application has been installed, then the MCD initiates the app and makes it the foreground app. If the application has not been installed, then the MCD will install the application, the initiates the app and makes it a foreground app. As noted above, in a manual approach, for example, a customer selects the MCD contact application, for example by pressing on an icon, which is displayed on the MCD's 100 screen, or some other button or physical trigger on the MCD 100, representing the MCD contact application.

In an exemplary embodiment, the MCD 100 includes near field communications capabilities. The MCD 100 includes hardware and software or firmware that enables the MCD 100 to act as an active NFC device as is known in the industry. The MCD 100 is established to operate in at least the current NFC signaling technologies, but not is limited to those signaling technologies, and any appropriate signaling technologies can be employed. The three signaling technologies include: NFC-A, which is also referred to as RFID Type A; NFC-B, which is also referred to as RFID Type B; and NFC-F, which is also referred to as FeliCA.

An exemplary tag is a near field communications enabled tag 101, which is typically a passive NFC device. In an exemplary approach, a NFC tag 101 is a small, relatively flat device that is enveloped in a sticker to permit easy and quick deployment. An NFC tag 101 can be programmed with data by a manufacturer, owner, and third party. Some NFC tags 101 employ a security mechanism to help control who has the ability to write and/or modify data on a NFC tag 101. In an exemplary approach, an NFC tag 101 is programmed with business contact information and business data information. The contact information includes information, or a digital representation thereof, on how to contact a business and may include a URL for the business. The business data information includes, for example, a description of the context of the tag and/or the type of service that may be requested. The data information may contain location information: e.g., which location of a store, where in the store the tag is located, what section of a store (e.g., appliances), or the type, kind, or contact information of employee to be contacted. The data information may also indicate the kind of service sought to be provided: e.g., contact an employee, general information about a product or service

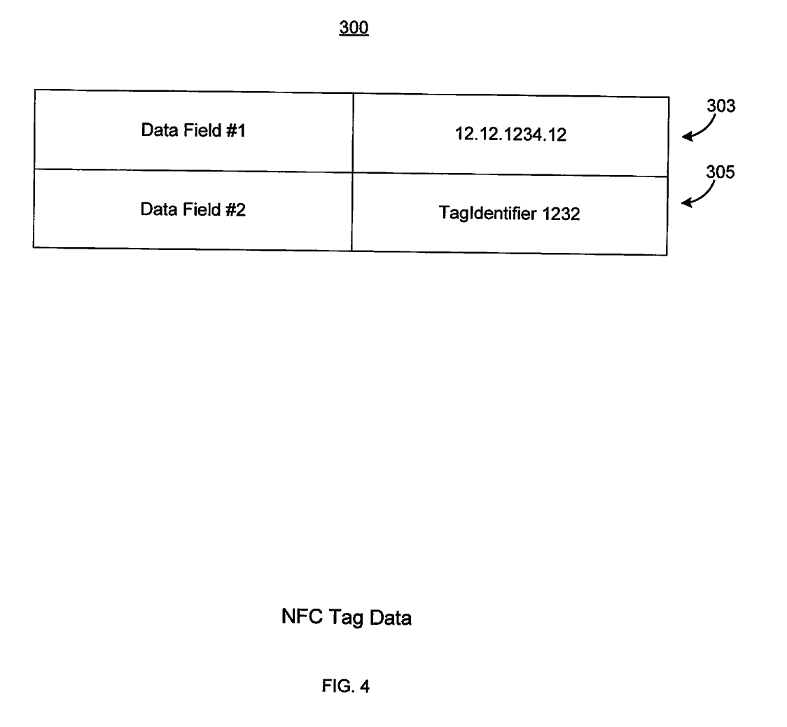

FIG. 4 depicts an exemplary NFC tag data packet contained in an NFC tag 101. In this example, the NFC tag data packet 300 of the NFC tag 101 contains two data fields, but the invention is not so limited and contains any number of appropriate data fields. The first data field 303 contains contact information for the business. In this example, the data field contains the URL for the business 110. The second data field 305 contains a unique identifier for the NFC tag 101, e.g., “TagIdentifier 1232.”

As is commonly known, in operation the MCD 100, which is the active device or reader, polls for nearby NFC devices. The NFC tag 101 begins to listen when it comes within a few centimeters of the MCD device 101. The MCD device 100 will then communicate with the NFC tag in order to determine which signaling technologies is to be used. When the NFC tag 101 responds to the MCD active device 100 indicating which signaling technology should be used, the MCD device 100 will set up a communication link with all the necessary parameters.

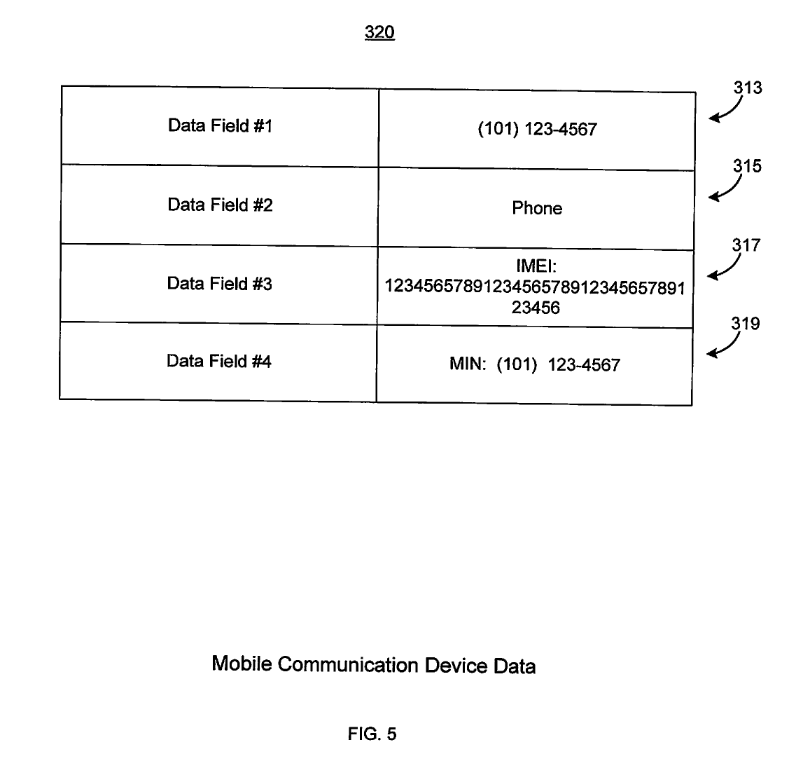

The MCD 100 includes a MCD data packet 320 which can be forwarded to the institutional server 105, which is depicted in FIG. 5. The data packet 320 is created by the MCD contact software by input from the customer and from data inherent to the MCD 100. The exemplary data packet 320 includes four data fields, but the invention is not so limited and contains any number of appropriate data fields. The first data field 313 includes the customer's preferred contact information. In this example, the contact information is the customer's phone number: (101) 123-4567. The second data field 315 contains the preferred communication approach. In this case, the customer's designated preferred communication approach is phone. The preferred communication approach can be a reasonable approach, including, but not limited to, for example, phone, SMS, email, data streaming. The contact information in the first data field should correspond to the preferred communication approach designated in the second data field. The third and fourth data fields 317, 319 include unique identifier for the MCD 100. For example, data field 317 includes the International Mobile Equipment Identity (IMEI) for the MCD 100, although other unique identifiers can be used, for example, the electronic serial number (ESN). Data field 319 includes the Mobile Identification number (MIN), although other unique identifiers can be used.

A business 110 has an institutional server 105, e.g., a business computer system (although referred to as a single system, the business may include a plurality of computer systems), that has installed a business contact software application, e.g., an “app,” for appropriate operations. An application can be downloaded from an appropriate source, e.g., CNET, iTunes, business website, etc., as is commonly understood. After downloading, the application is then installed, preferably, the application self installs on the business's computer system after downloading. In other aspects, the application is installed manually by a customer or other third party. After successful installation the software is ready to be activated. In certain operating systems, the business contact application executes as a background application until it is trigger, either manually or automatically in response to a signal received. For example in an automated approach, the business contact application runs in a background mode until it an appropriate signal is received by the business computer system. The business communications, and generally the web communications, are monitored by the business contact application and when it identifies a signal received that is an identified signal or one of a plurality of signals, then the business contact application sends an appropriate signal to the operating system to make the business contact application be a foreground application.

When a business computer system 105 receives an appropriate signal, the business contact software examines the tag data information and determines the type of service requested. If data is requested, then the business computer system looks up the data associated with the tag and determines the data to be provided. The business computer system uses the MCD information and causes a communication system of the business computer system to send the data to a MCD 100 that corresponds by the MCD information.

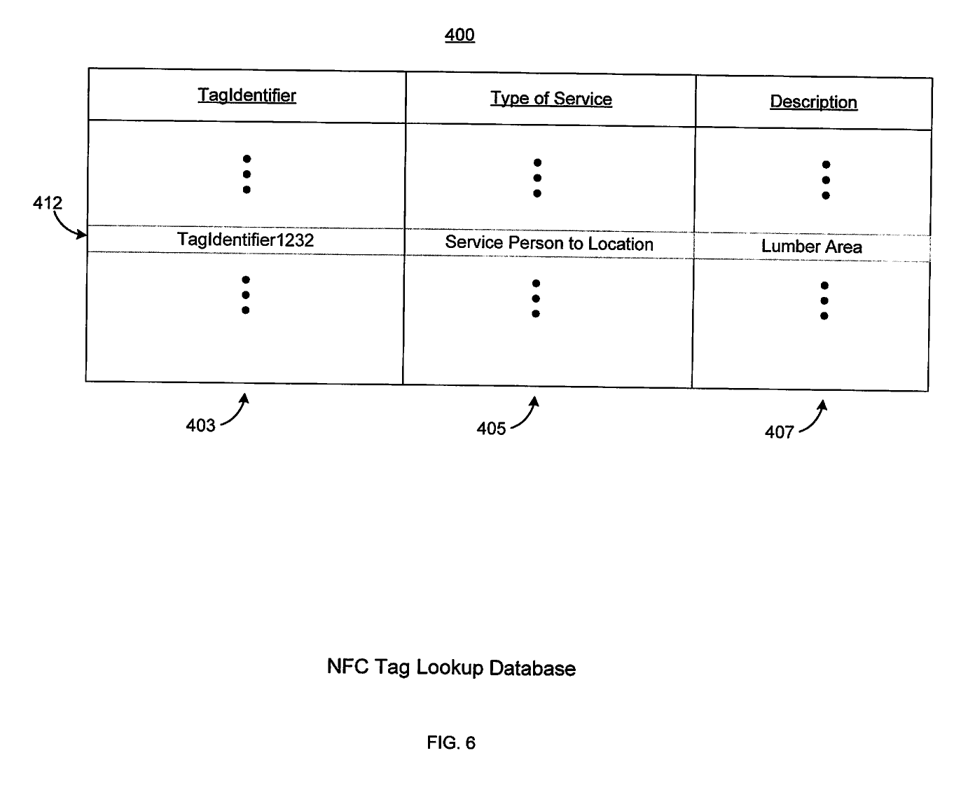

The business computer system 105 contains a NFC Tag lookup database 400, as depicted in FIG. 6. The exemplary database 400 includes a plurality of data sets and each data set has three data fields, but the invention is not so limited and can contain any number of appropriate data fields. The first data field 403 contains the tag identifiers. For clarity and simplicity, it is preferred that the NFC tags have unique identifiers. The second data field 405 indicates the type of service that corresponds to the unique identifier. For example, the type of service is “Service Person to Location”, “Data” or other appropriate service types. “Service Person to Location” indicates that an employee should respond to the location of the NFC tag. “Data” indicates that data should be provided. The third data field 407 provides a description corresponds to the unique identifier. For example, the description is “lumber area” indicating that the NFC tag corresponds to the lumber area of the business. Thus, for the data set 412, the data set corresponds to a NFC tag identified by TagIdentifier1232, which corresponds to the lumber area and requests that an employee respond to that location.

If the information on the NFC tag 101 indicates to the business computer system 105 the type of service requested is an employee, the business computer system 105 determines an appropriate employee (or employees) and contact information for that employee.

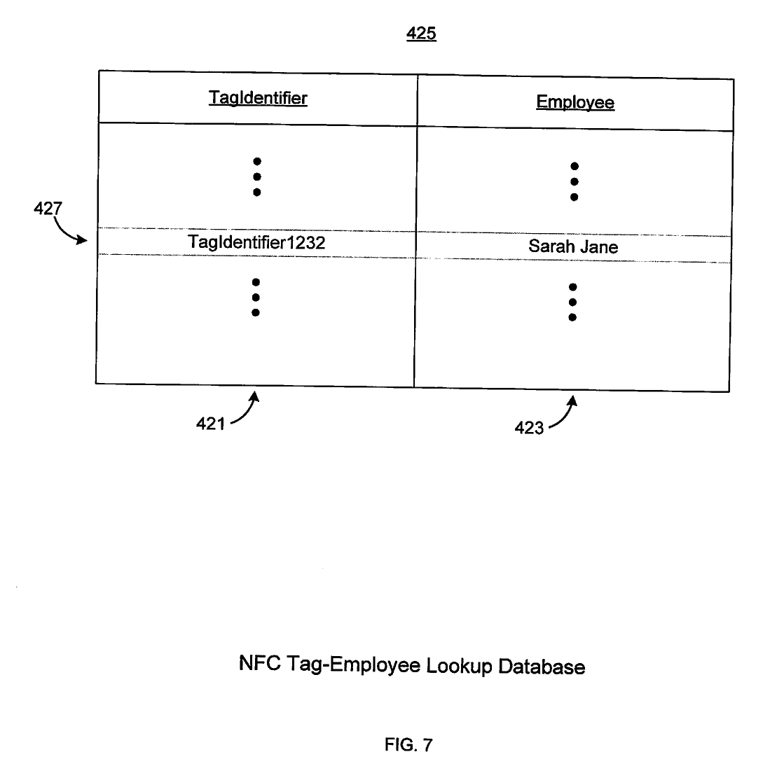

The business computer system 105 contains a NFC Tag-Employee lookup database 425, as depicted in FIG. 7. The exemplary database 425 includes a plurality of data sets and each data set has two data fields, but the invention is not so limited and can contain any number of appropriate data fields. The first data field 421 contains the tag identifiers. For clarity and simplicity, it is preferred that the NFC tags have unique identifiers. The second data field 423 indicates an employee that corresponds to the unique identifier. Thus, for the data set 427, the data set corresponds to a NFC tag identified by TagIdentifier1232, which corresponds to an employee Sarah Jane.

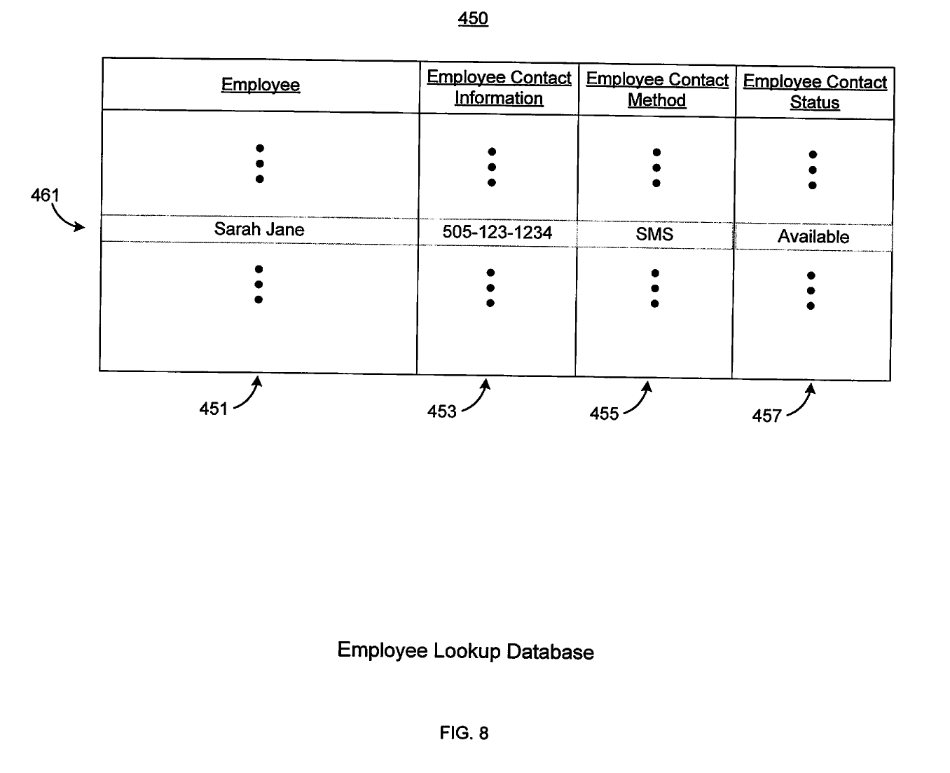

The business computer system 105 contains an Employee lookup database 450, as depicted in FIG. 8. The exemplary database 450 includes a plurality of data sets and each data set has four data fields, but the invention is not so limited and can contain any number of appropriate data fields. The first data field 451 contains names of employees. For clarity and simplicity, it is preferred that the names of employees are unique or have unique identifiers.

The second data field 353 includes the customer's preferred contact information. In this example, the contact information is the customer's phone number: (505) 123-1234. The third data field 355 contains the preferred communication approach. In this case, the customer's designated preferred communication approach is SMS. The preferred communication approach can be a reasonable approach, including, but not limited to, for example, phone, SMS, email, data streaming. The contact information in the second data field should correspond to the preferred communication approach designated in the third data field. The fourth data field 457 indicates the status of the employee. The status is, for example, “Available”, “Unavailable”, and “Busy”. Thus, for data set 461, Sarah Jane is the employee, her preferred method of contact is SMS and her contact information is 505-123-1234. At the present moment, Sarah Jane is available.

The business computer system 105 then causes a communication to be sent to the employee 107 through an associated MCD 106. Preferably, every employee has a MCD. For example, if an employee is requested, then the business computer system 105 determines that location of the store where the request is coming from, i.e., the location in the store where the NFC tag is located which the customer with MCD has read. The business computer systems 105 looks up in a database of the business an employee or employees associated with that tag. For example, the customer is located in a home improvement store and has scanned a NFC tag in the lumber area. The business computer systems looks up in an employee database, an employee or employees associated with the lumber area. The business computer system also looks up contact information and method for the employee(s). The contact method can be any reason method for communication, e.g., SMS, email, phone, page, etc. The contact information appropriate corresponds to the contact method. For example, if the contact method is SMS then the contact information is a SMS phone number. If the contact method is email then the contact information is an email address. If the contact method is phone then the contact information is a phone number. If the contact method is a page then the contact information is a pager number.

For example, the business computer system 105 looks up and determines that Sarah Jane is the employee associated with the TagIdentifier 1232—the lumber area. The business computer system 105 also looks up and determines that she is to be contacted through an SMS and that the contact SMS phone is 505-123-1234. Thus, the business computer system 105 causes a communication to be sent depending on the contact method, in this example an SMS is sent to Sarah Jane at 505-123-1234 requesting that she respond to the lumber area. The text of the SMS is, for example, “Please respond to customer in lumber area.” Email message and voice messages can also be employed and can provide similar messages or other appropriate messages.

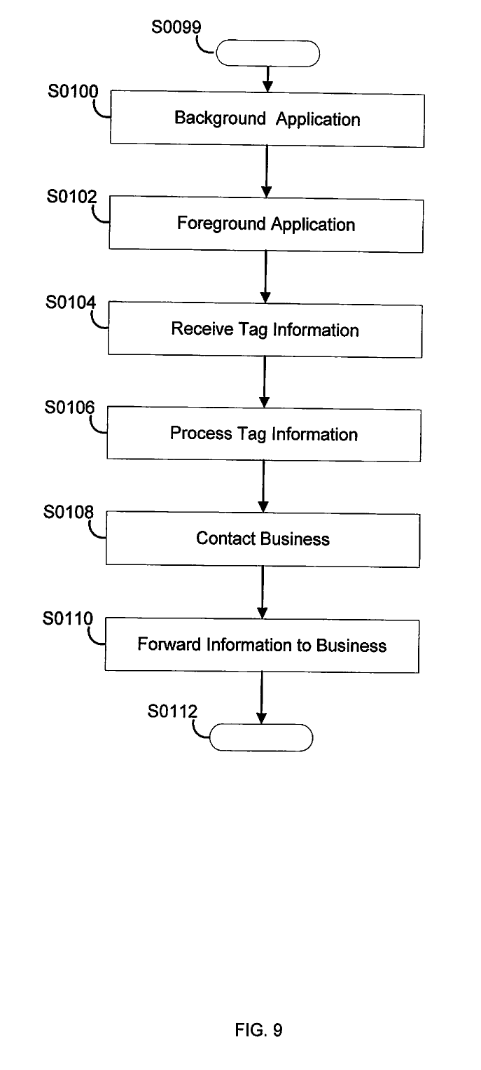

FIG. 9 depicts an exemplar process flow of a program on a MCD used in conjunction with a customer-business communication system.

In segment S0100, a customer with a MCD and preferably having previously installed appropriate MCD contact software for the context of the business enters a business. The MCD contact software runs or is dormant in the background of the operating system. If the appropriate MCD contact software for the context, e.g., the business, is not installed, it will be automatically downloaded and installed when the MCD is placed near the NFC tag of the venue and the NFC provides instructions to the MCD to download and install the appropriate MCD contact software for the context. Process flow continues to segment S0102.

In segment S0102, the MCD contact software is activated either manually or automatically. Process flow continues to segment S0104.

In segment S0104, the MCD 100 is placed near a desired NFC tag 101. Through NFC communications between the MCD 100 and the NFC tag 101, the MCD 101 receives a NFC Tag packet of NFC tag 101. Process flow continues to segment S0106.

In segment S0106, the MCD contact software interprets the data contained in the first data field of the NFC Tag packet and determines the contact information for the business computer corresponding to NFC tag 101. Process flow continues to segment S0108.

In segment S0108, using communication systems of the MCD, the MCD contact software contacts the business computer corresponding to the contact information of the first data field of the NFC Tag packet. Process flow continues to segment S0110.

In segment S0110, MCD contact software causes data to be sent to the business. The MCD contact software causes data from the second data field of the NFC Tag packet to be sent to the business. The MCD contact software also causes a MCD data packet to be sent to the business. Process flow continues to segment S0112.

In segment S0112, the MCD contact software returns to a standby status, either as a foreground or background process.

Thus, NFC tag information and MCD information has been sent to a business computer system 105 of a business 110.

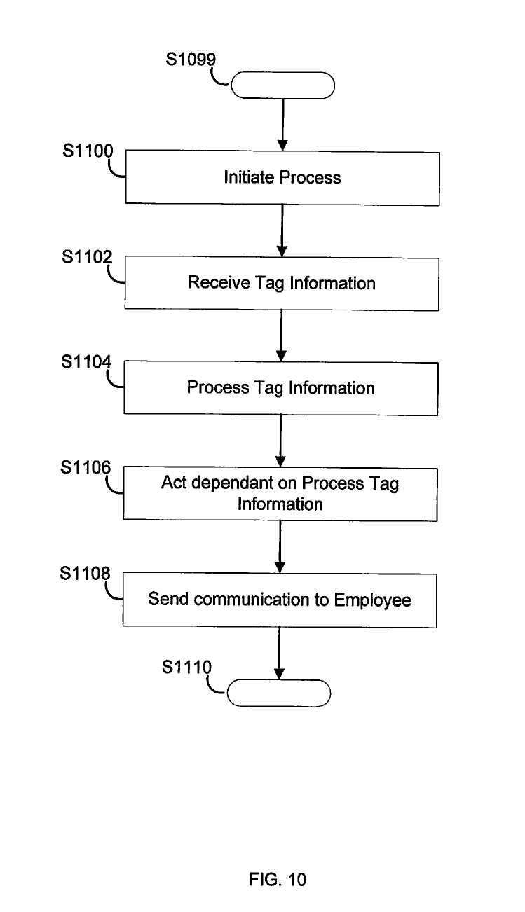

FIG. 10 depicts an exemplar process flow of a program on a business computer systems used in conjunction with a customer-business communication system.

In segment S1100, a business computer system 105 has installed business contact software and the software is executing. When the business contact software receives initial contact from a MCD running MCD contact software, process flow continues to segment S1102.

In segment S1102, the business contact software receives tag information from MCD contact software. The business contact software may also receive a MCD data packet. Process flow continues to segment S1104.

In segment S1104, the business contact software examines the data of tag information. The business contact software uses the data to determine the type of service requested using the NFC tag lookup database. Process flow continues to segment S1106.

In segment S1106, if the service request is requesting a service person respond to a location, then the business contact software using the NFC Tag-Employee database to look up an employee to send to the location. In this example, it is Sarah Jane. The business contact software uses the Employee database to determine how to contact Sarah Jane. Process flow continues to segment S1108.

In segment S1108, having determined how to contact the employee, the business contact software causes a communication, via SMS to 505-123-1234, to be sent to the employee, Sarah Jane, requesting that she respond to customer in the lumber area. Process flow continues to segment S1110.

In segment S1110, the business contact software continues to monitor communications for further communications from a MCD contact software.

Thus, a business contact software receives NFC tag information and sends a communication to an employee corresponding to that NFC tag information.

In a further aspect, the business computer system 105 tracks the contact status of each employee. For example, an employee status is AVAILABLE, UNAVAILABLE, BUSY, and UNKNOWN. The business computer system 105 tracks, alone or in conjunction with other business computer systems, the contact status of an employee. For example, if an employee is at work, then the employee is generally considered to be AVAILABLE. If she is not at work, then she is considered to be UNAVAILABLE. In a further aspect the business computer system tracks if an employee is AVAILABLE, the employee may be BUSY. For example, if an employee is at work and the employee is recently was requested to perform a service, then the employee is considered BUSY until released from this status. If an employee is not available or busy, then the business computer system 105 may attempt to find another employee to respond to the customer's request. This is discussed more fully below.

In another aspect, the business computer system 105 looks up and determines that there are several employees that can respond to an area. The computer 105 system then looks at the order and selects an employee according to an order. For example, the first time a service request for that area occurs, the employee with the first order is sent a message to respond. Then in a second service request for that same area, the employee with the second order is sent a message. When all of the employees have been sent messages, the requests begin again with the first ordered person. The order can be static or dynamic, e.g., for example, the order assigned to employees remains the same. For example, the business computer system is biased to always give Sarah Jane with the first order and so on. In another approach, the business computer system at designated times re-orders the order in which employees are requested.

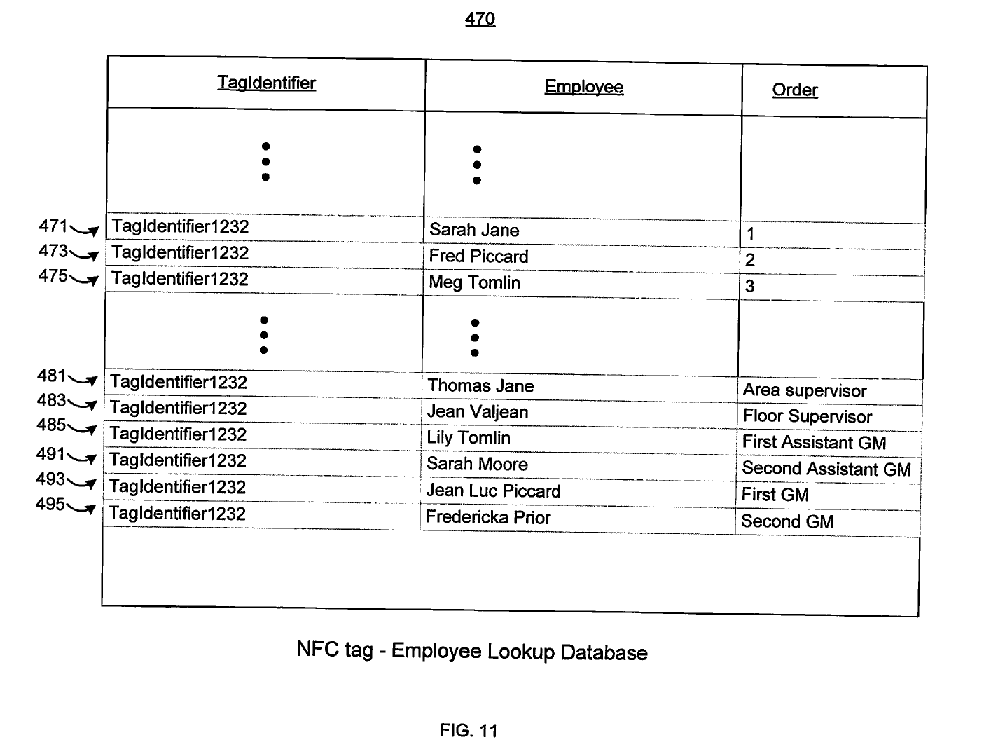

In another aspect, the business computer system 105 is designed with employees listed in the database and ordered to have employee contingencies in requesting employee to respond for service. For example, the business computer system 105 receives a request for a service person from a location identified as TagIdentifier 1232. See, for example, FIG. 11 which depicts an Employee lookup database having several employees who correspond to the same TagIdentifier1232. The business computer system 105 looks at employee(s) associated with that location and the status of the employee and works it through the list of employees to determine an appropriate employee to respond to that location. Therefore, the business contact software 105 looks at the employee lookup database having multiple employees that correspond to a single NFC tag and looks at their status. For example, if the first ordered employee is AVAILABLE, then a service request is sent to the first ordered employee. If the first ordered employee is UNAVAILABLE and the second ordered employee is AVAILABLE, then a service request is sent to the second ordered employee. Further, if the first and second ordered employees are UNAVAILABLE and the third ordered employee is AVAILABLE, then a service request is sent to the third ordered employee.

In another aspect, a management contingency is included with the employee contingency. Thus, if no employee is available to respond, then the business computer system 105 determines a person in the management of the business to be sent a request for response. This can seen, for example, in datasets 481, 483, 485, 491, 493, and 495 in FIG. 11. For example, the business computer system maintains a list of persons in the management of the business, for example, from area supervisors up to General Managers and conceivable to President or CEO as well as their contact status. The business computer system 105 determines that no employee is available that corresponds with TagIdentifier 1232, the business computer system 105 then determines a person in the management chain to respond, for example, a area supervisor. If business computer system 105 determines then the area supervisor is not available, then the business computer system 105 determines the next person in the management chain to respond, for example, a floor supervisor. If business computer system 105 determines then the floor supervisor is not available, then the business computer system 105 determines the next person in the management chain to respond, for example, a first assistant store manager. If business computer system 105 determines then the first assistant store manager is not available, then the business computer system 105 determines the next person in the management chain to respond, for example, a second assistant store manager. The management contingencies can be designed to list contingency through the business, e.g., with contingencies set up so that the president or owner of the business. The extent to which contingencies are programmed into the business computer system 105 system is variable and dynamic and can change at any time. For the purposes of the system, management personal may also be included when referring to employees.

Preferable, after an employee is receives a request to respond, the employee responds and the employee physically goes to the identified area, e.g., the lumber area, and looks for the customer requesting assistance.

Although the invention is described with respect to a business having a lumber area, the invention is not so limited and can apply to any business having a service component. For example, in a restaurant, NFC tags can be applied in, or around a table so that a customer can request a wait person.

In another aspect, after an employee is receives a request to respond, the employee responds both in person to the customer and to the business computer system 105. With respect to the business computer system 105, the employee communicates with the business computer system 105 that the employee has received the request to respond and is responding. The employee response can be in the same or different form of contact method as the request of response was sent. For example, an employee receives an SMS request to respond, the employee may respond to the business computer system 105 by SMS or by email. When business computer system 105 tracks the response from the employee 107. In an aspect, the employee can only respond that she has received the request. In an another approach, the employee can respond that she has received the request and Yes she is responding, or No she is unable to respond. In another approach, when employee approaches the customer who requested the service, the employee has an MCD with NFC capabilities. The employee using his MCD reads a customer's MCD device data which is forwarded by the employee's MCD to the business computer system 105. The business computer system 105 matches up at least some of the MCD device data with MCD device received from a customer when he requested service. In this way, the business computer system 105 attempts to track whether the customer is being served is the customer who requested service.

The business computer system tracks the response of the employee and may cause the business computer system to temporarily modify the status of the employee, e.g., to BUSY. The business computer system at a later time, modifies the employee's status to AVAILABLE, either at a default, preprogrammed period of time or after receiving a communication from the employee indicating a change of status. The business computer system maintains information about a request for service including the time elapsed between when a request for service is sent to an employee and when the business computer system receives notification back from the employee that when he arrived at customer. This information can be analyzed at a later time. In another aspect, the employee indicates to the business computer system when she has completed the interaction with the customer's request for service. In this aspect, the business computer system can track and analyze the service time for the request.

The business computer system can also be designed to implement a backup system should the employee not respond within a certain amount of time. The backup system could include re-paging—sending additional communication to—the employee and/or paging another employee to the customer. The back-up system remains in operation until a signal is received from the customer's mobile communication device indicating that an employee has responded to the customer. For example, the employee has an NFC enabled device which can include an NFC enabled mobile communication device or an NFC enabled Employee ID card, or anything device that can communicate via NFC. The employee is directed to touch their NFC enabled device to the customers NFC enabled device so as to turn off the page. Upon the customer initiating a page, the customer starts on the server and the NFC enabled device a clock. This clock defines the time it takes an employee to reach that customer and that clock can only be turned off by have the employee's NFC enabled device communicate to the customers NFC enabled device. Upon communication, it will then signal the server to turn off the timer. The timer keeps records of the time periods that an employee has taken to reach the customer. Management can use this date in multiple ways. Examples, to see average times that one employee or comparison of multiple employees take to reach a customer within periods of time such as days, weeks, or months. In another example, management can setup alarms such as if the time passes five minutes and the employee has not reached the customer, then management is informed that it's been more than five minutes and the employee has not yet reached the customer to service that customer.

In another aspect, the information on the NFC tag is used by the mobile communication devices to communicate directly with a business employee based on the information from the NFC tag. The information on the NFC tag is contact information for an employee or employees of the store, e.g., a phone number, a cell phone number, an email address, instant messaging address, etc. or a specified server that has intelligence and logic based on that NFC tag's location to define which employee to send the page request to. The mobile communication device uses the contact information to directly communicate, e.g., by calling, emailing, or other forms of communication, with the business employee.

In another aspect, in lieu of the computer system paging an employee to physically respond to the customer, which suggests that the employee is at the same or close to the location of the business, the computer system determines and tracks down (electronically) an appropriate employee, preferably without regard to the employee's location, and establishes communications between the customer and the employee. Thus, rather than the business computer system identifying an appropriate employee and her contact information and sending a communication to the identified employee, instead, the business computer system identifies an appropriate employee and her contact information, and then establishes a communication link between the customer and the employee. For example in a phone contact scenario, the business computer system using information from the customer's MCD data packet and the identified employee's contact information, the business computer system, using known technology, establishes a conference telephone call between the customer and the employee. Other communication scenarios can also be employed, for example connecting the two parties through SMS, email or otherwise. Furthermore, in the first scenario, communication is voice communication and/or may also include other media. For example, if the customer is in a home improvement store and the customer has a plumbing question regarding looking for a particular part, the customer can also use his mobile communication device's video/camera capabilities to show the employee the part that he is looking for.

In another aspect, a messaging or menu-ing system is provided to the customer through communications with his mobile communication device so that the customer can provide some information to the employee about his request. This information may be utilized to further identify an appropriate employee to respond to the customer. The menu-ing system includes questions and answers for the customer to respond to, where the answers may be pre-defined and/or may include a text entry option enabling the customer to provide his own input. The customer's responses are provided to the employee to ideally increase the efficiency and/or effectiveness of the response. For example the customer provides input indicating that he and his lunch companions want drink refills. The MCD contact software collects this information and provides this information to the business computer system 105 along with NFC tag data. This information is provided to the identified employee in addition to or in place of the communication sent to the identified employee, depending on the settings of the business computer system. Thus, the identified employee is more knowledgeable about the customer's request for service. For example, the customer indicates that he would like his drinks refilled. The employee knows what the customer wants before he gets to the customer and therefore responds to the table with drinks. Thus, the employee only has to respond to the customer once, rather than twice (e.g., a first response to find out what the customer wants and a second time to satisfy the customer's request).

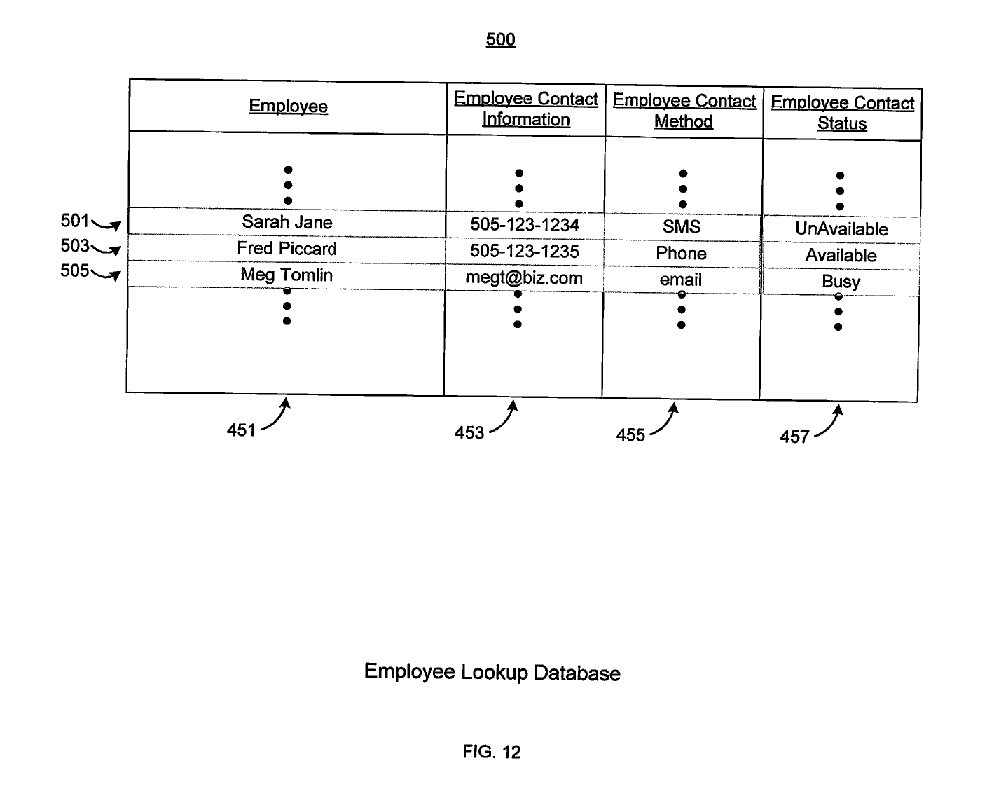

In another embodiment of a customer-business communication system, an MCD is connected to a business computer system and the MCD executes a program on the business computer system. Although this embodiment includes similar elements as described with respect to FIGS. 1-12, the operation of this customer-business communication system is a little bit different. Similar to FIG. 2, this embodiment includes an NFC tag 101, a MCD having near field communications capabilities 100, a wireless tower 103, a cellular server 104, an institutional server 105, a mobile communication device 106, and an employee 107.

However, in operation, the MCD determines the contact information for the business computer system. Using the contact information, the MCD causes a communication system of the MCD, e.g., the data communication system and Internet connectivity, to form a connection with the business computer system located at the contact information, e.g., 12.12.1234.12. In exemplary operation, a window opens in the browser of the MCD. The customer of the MCD uses her MCD to execute and interact with a business contact software application on the business computer system. The MCD 100 causes a NFC tag data packet 300 and MCD data packet 320 to be provided to the business computer system 105. The business computer system 105 uses the NFC tag data packet to determine the employee(s) to be contacted, as discussed above. This embodiment allows for the business 110 to provide a generic connection software, its version of the MCD contact software, and provide most implement changes/modifications to its business contact software. Thus potentially reducing the need for a customer to update software on her MCD.

As the customer is running a part of the business contact software on the business computer system 105, the business 110 has greater ability to interact with the customer and therefore easily increases the amount of information that a customer can easily provide to the business computer system for processing. For example, the business contact software can provide narratives, have an open text field for the customer to provide his own input, provide menus for responses from the customer on different topics, and can gather other input from the customer. For example, the business computer system receives the NFC tag data and therefore can determine the context of a tag, in this example, the tag is located at a table in a restaurant of the business. In the context of a restaurant, the business contact software can provide the customer with a food and beverage menu and have the customer place an order through her MCD. The business contact software is programmed to step the customer through the food and beverage menu and place the order in response to questions.

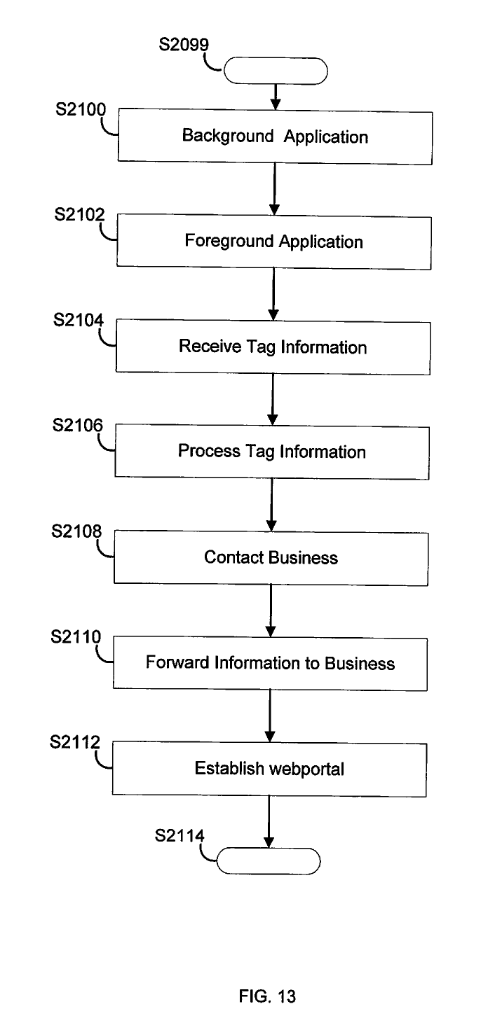

FIG. 13 depicts an exemplar process flow of a program on a MCD used in conjunction with a customer-business communication system.

In segment S2100, a customer with a MCD and preferably having previously installed appropriate MCD contact software for the context of the business enters a business. The MCD contact software runs or is dormant in the background of the operating system. If the appropriate MCD contact software for the context, e.g., the business, is not installed, it will be automatically downloaded and installed when the MCD is placed near the NFC tag of the venue and the NFC provides instructions to the MCD to download and install the appropriate MCD contact software for the context. Process flow continues to segment S2102.

In segment S2102, the MCD contact software is activated either manually or automatically. Process flow continues to segment S2104.

In segment S2104, the MCD 100 is placed near a desired NFC tag 101. Through NFC communications between the MCD 100 and the NFC tag 101, the MCD 101 receives a NFC Tag packet of NFC tag 101. Process flow continues to segment S2106.

In segment S2106, the MCD contact software interprets the data contained in the first data field of the NFC Tag packet and determines the contact information for the business computer corresponding to NFC tag 101. Process flow continues to segment S2108.

In segment S2108, using communication systems of the MCD, the MCD contact software contacts the business computer corresponding to the contact information of the first data field of the NFC Tag packet. Process flow continues to segment S2110.

In segment S2110, MCD contact software causes data to be sent to the business. The MCD contact software causes data from the second data field of the NFC Tag packet to be sent to the business. The MCD contact software also causes a MCD data packet to be sent to the business. Process flow continues to segment S2112.

In segment S2112, the MCD contact software causes the MCD to establish communications with the business computer system. A browser window opens in the MCD with a portal to the business computer system, thereby executing aspects of the business computer system through the MCD. When the communication is completed, process flow continues to segment S2114.

In segment S2114, the MCD contact software returns to a standby status, either as a foreground or background process.

Thus, NFC tag information and MCD information has been sent to a business computer system 105 of a business 110. Further a web portal is opened from the MCD to the business computer system to allow a customer to execute aspects of the business computer system contact software.

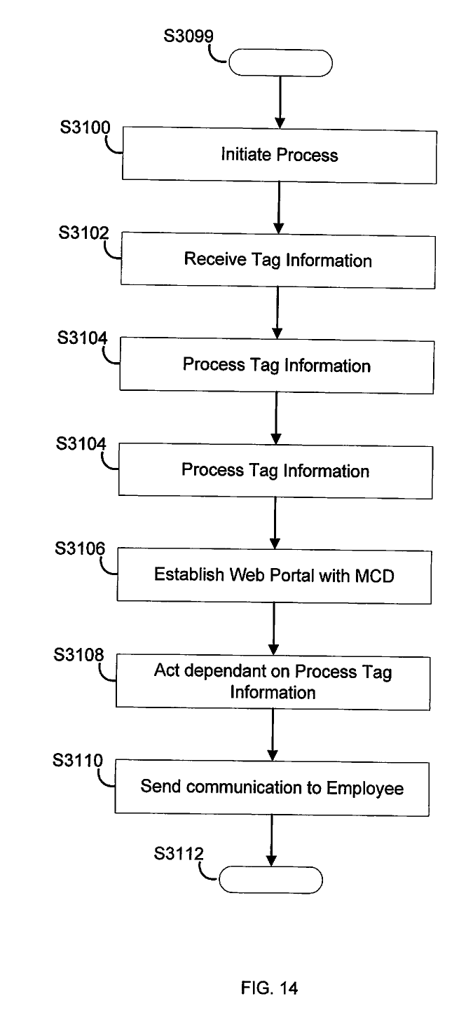

FIG. 14 depicts an exemplar process flow of a program on a business computer systems used in conjunction with a customer-business communication system.

In segment S3100, a business computer system 105 has installed business contact software and the software is executing. When the business contact software receives initial contact from a MCD running MCD contact software, process flow continues to segment S3102.

In segment S3102, the business contact software receives tag information from MCD contact software. The business contact software may also receive a MCD data packet. Process flow continues to segment S3104.

In segment S3104, the business contact software examines the data of tag information. The business contact software uses the data to determine the type of service requested using the NFC tag lookup database. Process flow continues to segment S3106.

In segment S3106, using information from a MCD data packet, the business computer system causes a web portal to be opened with the MCD. The business computer system then, if programmed so, provides additional programming features to the customer. For example, the business computer system provides a restaurant menu to the customer and steps the customer through the menu to order items. The business computer system may also prompt the customer for any additional narrative—text—to be provided to the employee. Process flow continues to segment S3108.

In segment S3108, if the service request is requesting a service person respond to a location, then the business contact software using the NFC Tag-Employee database to look up an employee to send to the location. In this example, it is Sarah Jane. The business contact software uses the Employee database to determine how to contact Sarah Jane. Process flow continues to segment S3110.

In segment S3110, having determined how to contact the employee, the business contact software causes a communication, via SMS to 505-123-1234, to be sent to the employee, Sarah Jane, requesting that she respond to customer in the lumber area. The communication may include information acquired by the business computer system from the customer during segment S3108. Process flow continues to segment S3112.

In segment S3112, the business contact software continues to monitor communications for further communications from a MCD contact software.

Thus, a business contact software receives NFC tag information and sends a communication to an employee corresponding to that NFC tag information.

Although the example described above talks in reference to a web portal, the invention is not so limited, and any comparable communication method can be used to establish communications between a MCD and business computer system, whereby a customer of the MCD executes programs that, for all intents and purpose, reside and are executed on the business computer system.

A programming system is available to the service establishment which permits quick programming of the menu-ing system that is provided to a customer via his mobile communication device. The programming system allows a programmer to quickly modify the questions/choices presented to the customer. The programming system can provide any number of questions/choices to the customer and can receive customer's responses in the form of a preselected list and/or a text entered by the customer on his mobile communication device. The programming system allows dynamic customization of questions/choices for different locations of the service provider. The customizations can be saved and used for future events. For example, a multi-use stadium providing food service will have a first set of questions/choices for a first event type (e.g., baseball) and a second set of questions/choices for a second event type (e.g., football), and a third set of questions/choices for a third event type (e.g., rock concert). In an aspect, the dynamic customization enables customization of menu-ing format, layout, and design.

In another exemplary embodiment, the customer can order items or services via a predefined or dynamic menu-ing system, where the order information is sent to a specific location for the retailer defined by the NFC tag or NFC reader that is placed in that specific location and uses logic based on that location to communicate that order to a specific location for that retailer. An example, a deli counter, the customer communicates via NFC to define the location and accesses specific menu listing where they can interact via their mobile communications device to place an order securely and receive a communication via SMS, phone call, or other communication media that their order is ready for pick up and or payment. In another example, the customer is in a stadium and the stadium may have multiple of the same retailer but located in different areas of the stadium. The retailer may be Nathan's Hot Dogs™ and there are five Nathan's Hot Dog™ locations. The system will communicate the order to the nearest Nathan's Hot Dog Stand™ to where the customer communicated with their NFC enabled device to the retailers NFC reader or tag.

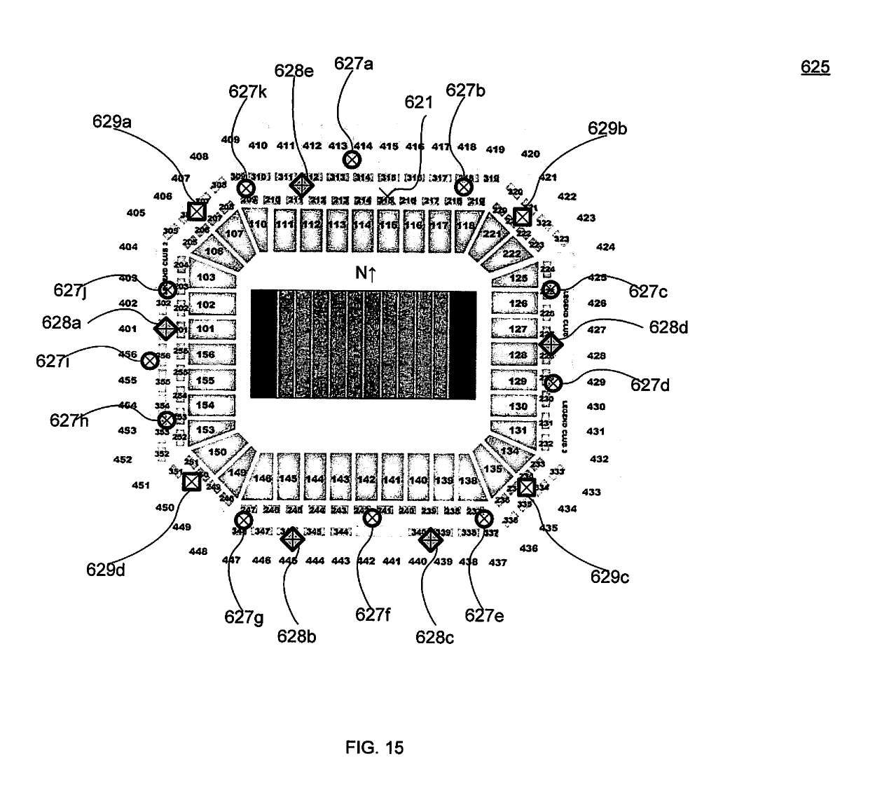

For example, a customer 621 having a MCD is attending an event in a large stadium 625 as depicted in FIG. 15. The customer 621 is seated in section 215 in the north side (“NT”) of the stadium 625. Each seat in the stadium has a NFC tag located on the seat back/wall/railing in front of the seat. A NFC tag is a sticker-like tag, e.g., NFC tags available from Narian Technologies, which can be easily peeled and placed on a desired location. Each NFC tag is programmed to uniquely identify its location.

The stadium 625 offers a variety of food and beverage options. It is common for a food/beverage purveyor to have multiple locations through the stadium. For example, Krispy Kreme™ has eleven locations 627a-k in the stadium, Hooters™ has four locations 629a-d in the stadium, and Nathan's Hot dogs has five locations 628a-e in the stadium.

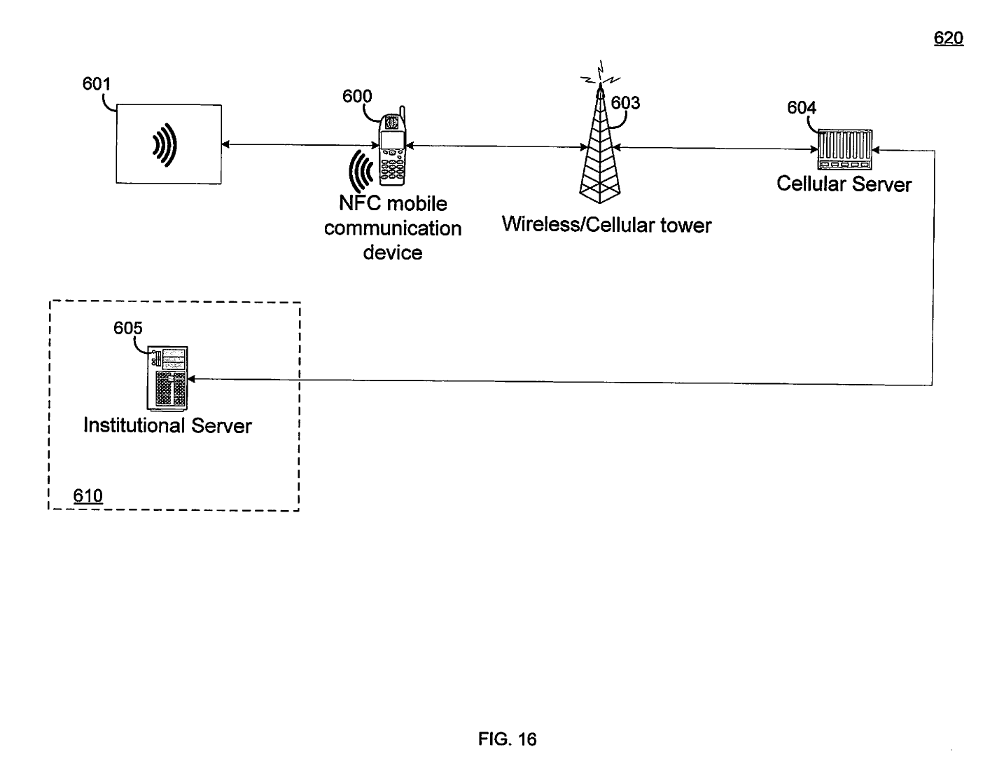

In the exemplary embodiment depicted in FIG. 16, the customer-business communication system 620 includes an NFC tag 601, a MCD having near field communications capabilities 600, a wireless tower 603, a cellular server 604, and an institutional server 605 of a business 610, e.g., a food or beverage purveyor. The customer-business communication system 620 enables a customer to place an order for food/beverage from or near seat where she is currently located, thereby ordering food/beverage in advance of her going to the food/beverage purveyor's location to pick up the order. The customer-business communication system 620 determines the closest purveyor to the customer and sends the order to that location. The customer can also reduce wait time and inconvenience by paying for her order through the customer-business communication system 620, thereby not having to perform a payment transaction at the purveyor. The purveyor sends a message to the customer when the order is ready, thereby reducing the amount of time a customer has to wait for her food at the purveyor stand.

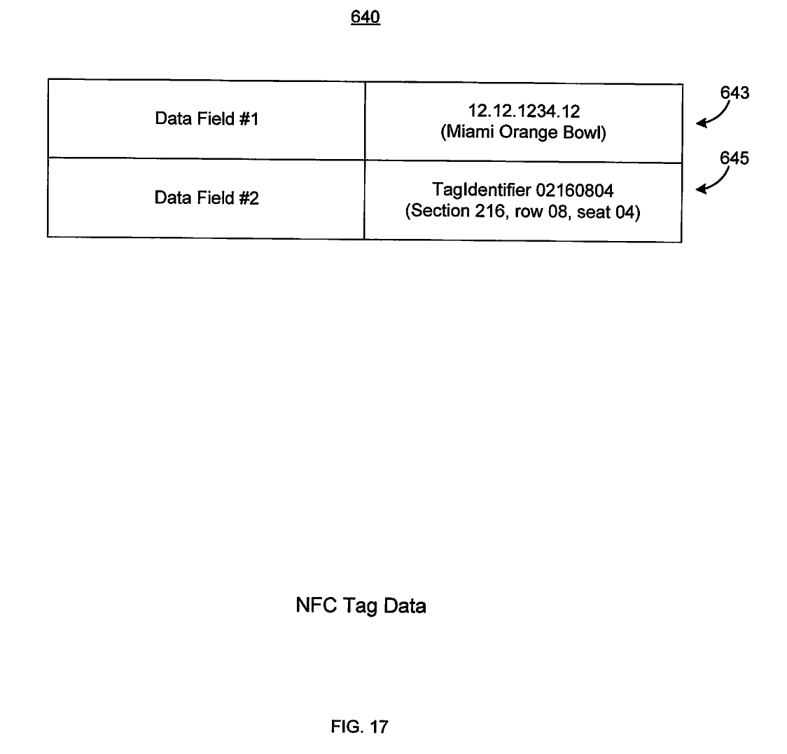

The NFC tag 601 has been appropriately programmed to include at least data representing the venue of its application, as well as unique data identifying the NFC tag. A venue generally a relatively confined area and in most cases applies to a relatively closed environment, e.g., a stadium (e.g., the Miami Orange Bowl) or baseball stadium, football stadium, concert stadium/hall, strip malls, etc. The invention is not limited to venues, but can apply to open venues, e.g., larger, open areas, like, for example, areas of town, like South Beach or Coral Gables. FIG. 17 depicts a representation of data stored on the NFC tag 601. In the exemplary approach, the NFC tag data 640 includes in the first data field 643 the venue represented by “12.12.1234.12”, which is the identifier for the Miami Orange Bowl. The second data field 645 includes a unique tag identifier represented by “02160804” which is supposed to represent Section 216, row 08, seat 04 in the Miami Orange Bowl stadium.

In an exemplary approach, the MCD 600 has installed MCD contact software for the context, as described above. The business computer system 610 has installed business computer system software as described above.

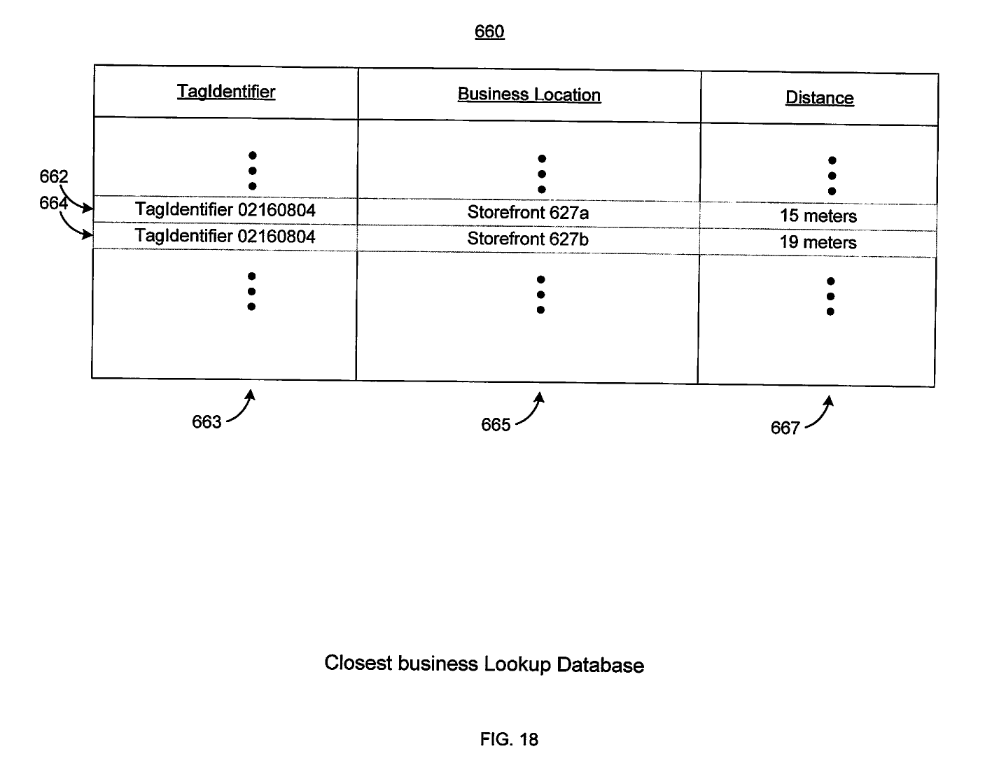

The business computer system includes a system for determining the location of its purveyors within a context and the location of NFC tags. In an exemplary approach, the business computer system includes a lookup database 660 as depicted in FIG. 18. The lookup database 660 includes a list of NFC tags as identified by their unique identifier in filed 663, list of its purveyor locations 665, and the distance between the NFC tag 601 and each purveyor's location. Thus, the database 660 stores the location of the NFC tag 601, the purveyor location, and it (or some other system) has determined the distance between the two locations and has stored the distance in the database. Thus, given a NFC tag, the business computer system can determine and identify the closest purveyor location. The invention is not limited to this approach to determining distance between an NFC tag and purveyor and thereby determining the closest purveyor, and other approaches can be used, including Cartesian approaches, whereby each location is stored on a map and distances are calculated between the two locations.

In exemplary use, a customer seated in a stadium seat is hungry and/or thirsty and would like to order something to eat and/or drink. The customer places her MCD an NFC tag 601, preferably an NFC tag at or near where she is located. The MCD 600 recognizes the venue and starts the MCD contact software for the stadium. The MCD contact software provides the customer with a menu with choice of stadium purveyors, e.g., Nathan's Hot Dogs™, Krispy Kreme™, and Hooters™ The customer selects her preference and the MCD contact software directs the customer to purveyor. The purveyor MCD contact software may be incorporated as part of the Stadium MCD contact software, e.g., a sub-application. In another approach, the stadium MCD contact software initiates a different MCD contact software on the MCD for the purveyor. In another approach, the MCD contact software opens a web portal to the business computer system of the purveyor.

The purveyor MCD contact software provides a menu of food/beverages for customer. The customer places an order—she provides input and selects food and/or beverages from the purveyor. When the order is complete the order is forwarded to the purveyor's business computer system. The purveyor's business computer system determines where the customer is ordering from (based on the NFC tag) and the closest location of the purveyor in the stadium and directs the order to that location of the purveyor. The business computer system sends an order confirmation to the customer's MCD. The business computer system indicates which location of the purveyor is preparing the order. When the purveyor has completed preparing the order, the purveyor's business computer system sends a message to the customer indicating that the order has been prepared and is ready for pickup.

In a preferably approach, at the conclusion of placing her order, the business computer system allows the customer is able to pay for the order using payment systems through her MCD, typically through a third party system. The business computer system receives confirmation of payment.

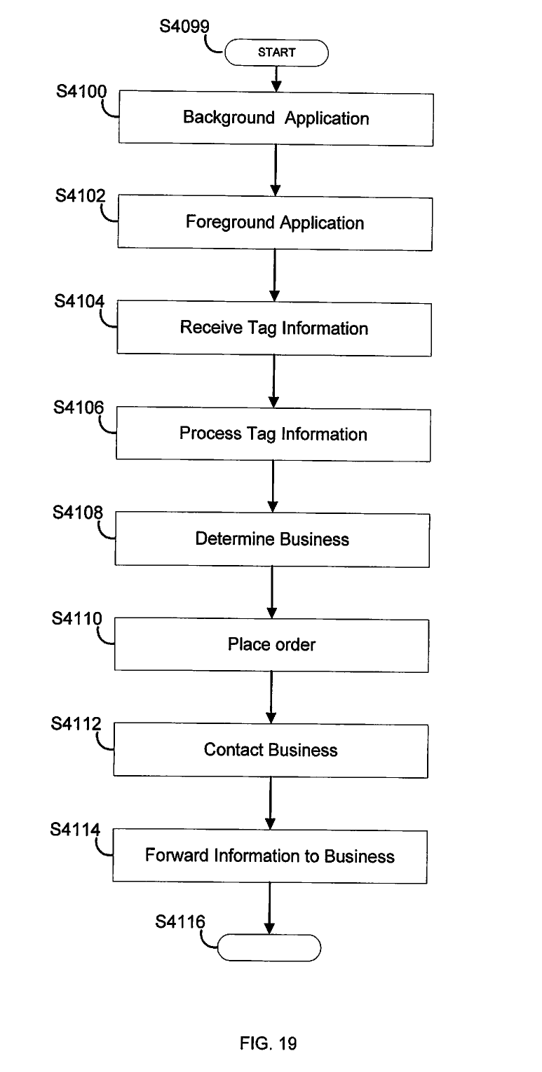

FIG. 19 depicts an exemplar process flow of a program on a MCD used in conjunction with a customer-business communication system.

In segment S4100, a customer with a MCD and preferably having previously installed appropriate MCD contact software for the context of the business enters a business. The MCD contact software runs or is dormant in the background of the operating system. If the appropriate MCD contact software for the context, e.g., the business, is not installed, it will be automatically downloaded and installed when the MCD is placed near the NFC tag of the venue and the NFC provides instructions to the MCD to download and install the appropriate MCD contact software for the context. Process flow continues to segment S4102.

In segment S4102, the venue MCD contact software is activated either manually or automatically. Process flow continues to segment S4104.

In segment S4104, the MCD 100 is placed near a desired NFC tag 101. Through NFC communications between the MCD 100 and the NFC tag 101, the MCD 101 receives a NFC Tag packet of NFC tag 101. Process flow continues to segment S4106.

In segment S4106, the MCD contact software interprets the data contained in the first data field of the NFC Tag packet and determines the confirms the context and makes sure that the correct MCD contact software is executing. In this example, the MCD contact software identifies that the MCD is in the Miami Orange Bowl and makes sure that the Miami Orange Bowl business MCD contact software application is running. Process flow continues to segment S4108.

In segment S4108, the customer through the MCD contact software selects, a purveyor for food/beverages, e.g., Nathan's Hot Dogs. The Miami Orange Bowl MCD contact software executes sub-application for Nathan's Hot Dogs or a separate Nathan's Hot Dogs MCD contact software application. Process flow continues to segment S4108.

In segment S4108, the customer places her order for food and/or beverages using the Nathan's Hot Dogs MCD contact software. When the customer has completed her order, process flow continues to segment S4108. In another option, when the customer has completed her order, the customer is prompted to pay for her order. When confirmation of payment is received, process flow continues to segment S4108.

In segment S4108, using communication systems of the MCD, the Nathan's MCD contact software contacts its corresponding business computer corresponding to the contact information identified by the Nathan's MCD contact software. Process flow continues to segment S4110.

In segment S4110, MCD contact software causes data to be sent to the business. The MCD contact software causes data from the second data field of the NFC Tag packet to be sent to the business. The MCD contact software also causes a MCD data packet to be sent to the business. The MCD contact software also causes a payment confirmation to be sent to the business. Process flow continues to segment S4112.

In segment S4112, the MCD contact software returns to a standby status, either as a foreground or background process.

Thus, NFC tag information and MCD information has been sent to a business computer system 605 of a business 610.

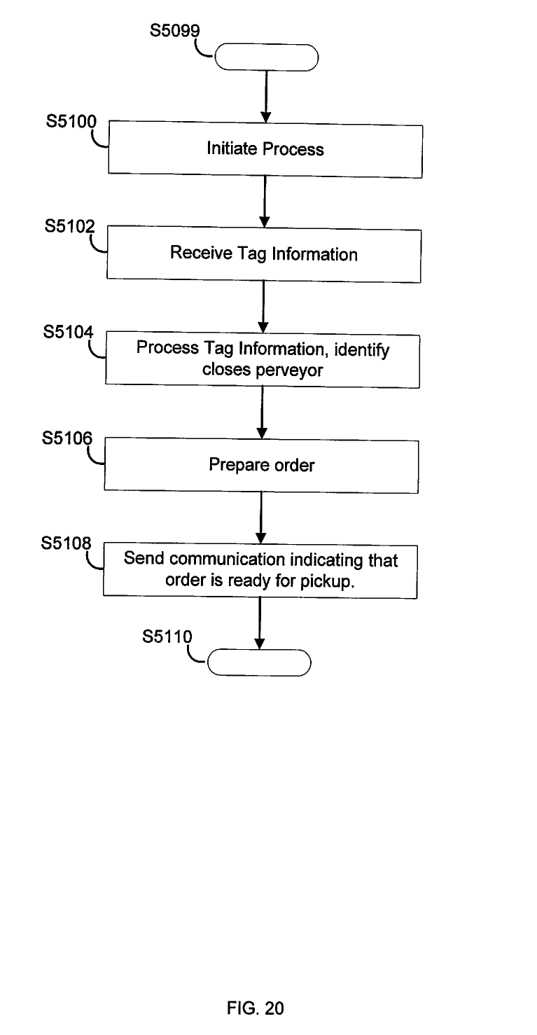

FIG. 20 depicts an exemplar process flow of a program on a business computer systems used in conjunction with a customer-business communication system.

In segment S5100, a business computer system 605 has installed business contact software and the software is executing. When the business contact software receives initial contact from a MCD running MCD contact software, process flow continues to segment S5102.

In segment S5102, the business contact software receives tag information from MCD contact software. The business contact software also receives a MCD data packet. The business contact software may also receive payment information. Process flow continues to segment S5104.

In segment S5104, the business contact software examines the data of NFC tag information. The business contact software uses the data to the venue, e.g., the Miami Orange Bowl, and the location of the NFC tag, to determine the location and identification of the closest purveyor to the NFC tag using the NFC tag lookup database, e.g., database 660. Process flow continues to segment S5106.

In segment S5106, the business contact software provides to the business computer system of the identified closes purveyor, the NFC tag information, MCD tag information, the order information, and possibly, payment information. Process flow continues to segment S5108.

In segment S5108, the identified purveyor prepares the order. When the order has been prepared, the business computer system of the purveyor, using MCD tag information and the order information, sends a message to the MCD indicating that the order is ready for pickup.

In segment S5110, the business contact software continues to monitor communications for further communications from a MCD contact software.

Thus, an order has been place by a customer in the stadium and then goes to pick up the order at the closest purveyor when the order is complete.

After receiving the message that the order has been prepared and is ready for pickup, the customer proceeds to the purveyor's location. The customer confirms with the purveyor that she is the purchaser and picks up her order. The order is confirmed by matching the customer to the order, more specifically, matching the customer's MCD to the order. In an approach, the MCD contact software is programmed to provide the customer an option of displaying an order confirmation number received from the purveyor. In another approach, the customer approaches a NFC reader at the location of the purveyor and the MCD contact software provides at least a portion of the MCD data packet (FIG. 5) to the NFC reader, e.g., the IMEI. The purveyor's business computer system compares the information of the MCD data packet, e.g., the IMEI, to the information of the MCD data packet that is associated with the order. If the information matches, then the order belongs to the customer and the purveyor should then provide the food/beverage to the customer.

By ordering from or near her seat, a customer can reduce the amount of time that she has to wait to pick up the food/beverage order from the business, which serves as an obvious benefit to the customer. If a customer can decrease her expected wait time, it is likely that there will be increase in her likelihood to order food/beverages, especially placing additional orders for food/beverages.

As more customers order ahead using their MCDs, businesses prepare more foods/beverages in according with actual demand as opposed to projected demand. As such, the business may only prepare food/beverages that are desired, which could reduce the creation of unwanted/unneeded food/beverages.

A further aspect is the increased security of a customer's order. As NFC communications are inherently conducted within a very close distance between the NFC reader (e.g., a MCD with NFC capabilities) and an NFC tag, it is nearly impossible for a NFC reader not close to the NFC tag to access information contained on the tag. If the NFC tag is encoded with unique, identifying information, then only a limited number of people who can access the NFC tag information and it would be difficult, and nearly impossible, for someone not located near the NFC tag to determine and/or access information contained in the NFC tag. Therefore, the use of NFC tags in ordering can reduce fake orders.

In another aspect, a payment processing system is incorporated into the customer-business communication system. The customer at or towards the end of her order causes payment to be made to the business. Payment processing can either be done through the MCD contact software or the business computer system contact system or a combination of both. In a preferably approach, the MCD contact system incorporates a payment processing system. A payment processing system such as that of First Data Corporation processes all forms of payments for a plurality of merchants including a plurality of restaurants. For example, when the payment processing system receives a credit card payment authorization request from the MCD contact system, it routes the request to the appropriate interchange system such as VISA™ which then routes the request to the issuing bank of the credit card. The process is reversed for a payment authorization. The authorization message from the issuing bank is routed to the interchange system and then to the acquirer which routes it to the payment processing system. The authorization is then provided by the MCD contact software to the business contact software. Thus, when the payment is confirmed, the customer only has to pick up the items, and neither the business nor the customer have to take time to process payment when the customer arrives at the business.

In another aspect, the food and beverage menu offerings are dependent on where the customer's seat is located. In exemplary approach, if a customer is seated in the more expensive seats, then more food and/or beverage options and more expensive items are made available only to those in certain areas. Similarly, if a customer is seated in the relatively inexpensive seats, few items and cheaper items are made available to them.

In another aspect, the purveyor delivers the order to the customer. The purveyor uses information from the NFC tag data corresponding to an order to determine the location of the customer and delivers the order to customer at that location.

In an aspect, a purveyor may have multiple locations in a venue. However, it is not uncommon that not all locations are the same in what they offer. For example, a first location and only the first location of Hooters offers skinless buffalo wings. The remaining locations in the venue do not offer skinless wings. Therefore, when placing the order, the business computer system determines what is the closest location that offers the items request. Further, if the location that offers the item is not the closest location of the purveyor to the customer, then the business control system communicates this to her and gives her the option of maintaining her order or changing the order to only order items that are available at the closest location.

In another aspect, the mobile communication device system is used as a recipient of page from a business, for example, based on a queuing or some other ordering system which could be used in such scenarios as a deli or a bank line, as seen for example in FIGS. 1 and 3. For example in FIG. 3, in a store or restaurant, a customer-business communication system—a customer “paging” system—is used by a business to communicate with a customer, e.g., to let them know that it is or is about to be their time for service.

The consumer can tap, i.e., placing their NFC device within close enough proximity of another NFC device that allows NFC communications between their mobile communication device to a NFC reader or NFC tag. The NFC reader in the deli scenario, depicted representationally in FIG. 3, receives customer information from the customer's mobile communication device through a NFC communication. That customer information is contact information of the customer, e.g., the mobile communication device phone number or email address of the consumer. The reader at the deli, working alone or in conjunction with a computer server, has pre-defined rules that will send a page at an appropriate time when it is the customer's time for service. The reader at the deli, either alone or in conjunction with a server sends a page through an Internet connection or telephone system to the customer's mobile communication device; the server receives updates as customers are processed through the queue and when the service is ready for the next customer. The customer can receive that page via SMS, MMS, phone call, or other communications protocol. The queuing system and hierarchy can be maintained either at the reader or the reader can simply communicate the information to a server that has an application which controls and processes the paging and queuing of the service entity, e.g., the deli.

In another exemplary use in a bank, as depicted representationally in FIG. 3, an NFC reader 101 located on a bank service counter which reads a customer's mobile communication device 102 having NFC capability and receives contact information. The NFC reader 101 communicates the contact information to its associated computer system 105. The computer system 101 maintains a queuing system and, when the time is appropriate in the progression of the queue to page, the customer the computer system 105 communicates with a cellular server 104 and using the contact information contacts the customer's mobile communication device 102 through its tower 103 and indicates a signal indicating a page.

In another aspect of the service scenario, e.g., a deli, a consumer continues to shopping and is paged based on a predefined advanced notice, e.g., when there is only two people before him in the queue. This customer-business communication system creates efficiency for commerce and service by wasting less time for the consumer. In an exemplary use in a deli restaurant, as depicted representationally FIG. 3, an NFC reader 101 located on a deli service counter which reads a customer's mobile communication device 100 having NFC capability and receives contact information. The NFC reader 101 communicates the contact information to its associated computer system 105. The computer system 105 maintains a queuing system and, when the time is appropriate in the progression of the queue to page the customer, the computer system 105 communicates with a cellular server 104 and using the contact information contacts the customer's mobile communication device 100 through its tower 103 and indicates a signal indicating a page.

In another example of the invention, the customer uses their NFC enabled device to read an NFC tag which defines which specific location that customer is at such as a specific counter in a grocery store, in this case a deli counter versus the bakery counter. The customer's NFC enabled device takes that information from the NFC tag and communicates to the server which customer and which retail location and other such information and places the customer in the queue. In another embodiment of the invention, the customer has the ability to select what predefined number of customers in front of them in line that they should be paged at. For example, if there are 11 people in line in front of that specific customer and this customer is number 12, rather than paging the customer at the moment that 12 is queued, the customer may have selected to be paged when 3 people are left in line in front of them, giving them time to return without losing their turn. So rather than being paged when the number 12's turn is up, the customer will be paged when customer number 9's turn is up, giving them the ability to have time buffer to return back to the counter.

In an aspect, a periodic signal is sent to the customer indicating his place in the queue. The signal is received by the customer's mobile communication device and using the appropriate application on the mobile communication device, the mobile communication device displays the customer's place in the queue. Thus, the customer is informed as to his current status in the queue.

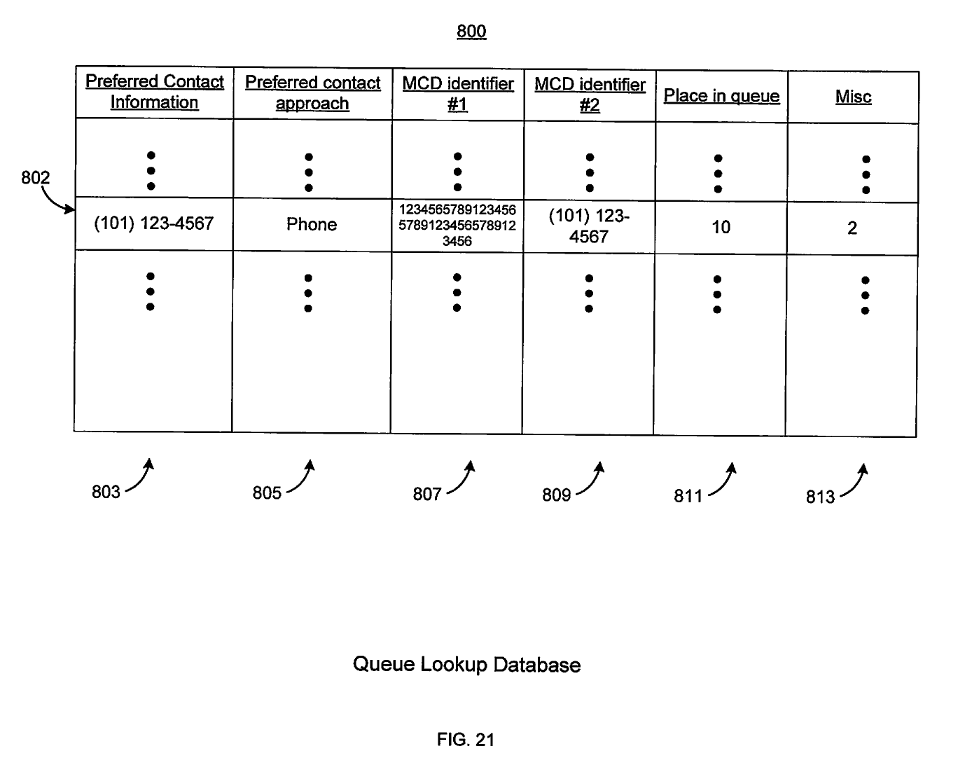

When the customer through his MCD contact software indicates to the business that he wants to enter a queue for service, the MCD contact software forwards a MCD data packet to the business computer system contact software. The business computer system 105 receives a MCD data packet from the MCD contact software. The business computer system 105 understands what queue this request for placement in the queue corresponds to and places the customer in the queue, thereby storing his contact information as part of the queue's information. An exemplary queue database 800 is depicted in FIG. 21.

Each data set 802 includes a plurality of datafields; this exemplary database includes six data fields, although the invention is not so limited. The first data field 803 includes the customer's preferred contact information. In this example, the contact information is the customer's phone number: (101) 123-4567. The second data field 805 contains the preferred communication approach. In this case, the customer's designated preferred communication approach is phone. The preferred communication approach can be a reasonable approach, including, but not limited to, for example, phone, SMS, email, data streaming. The contact information in the first data field should correspond to the preferred communication approach designated in the second data field. The third and fourth data fields 807, 809 include unique identifier for the MCD 100. For example, data field 807 includes the International Mobile Equipment Identity (IMEI) for the MCD 100, although other unique identifiers can be used, for example, the electronic serial number (ESN). Data field 809 includes the Mobile Identification number (MIN), although other unique identifiers can be used.

The business computer system also includes two additional data fields. Data field 811 reflects the customers place in the queue. This number is updated according to the processing of customers. Data field 813 is a field used to provide additional instructions to the business computer system. For example, the “2” in data field 813 indicates that the business computer system should send a message to the customer when he is in the second position in the queue. If the business employs more than one queuing system, the some type of queue identification system should be used to ensure that the customer is placed on the correct queue.

The business computer system updates the queue in response to customers being processed and their service completed at the business.

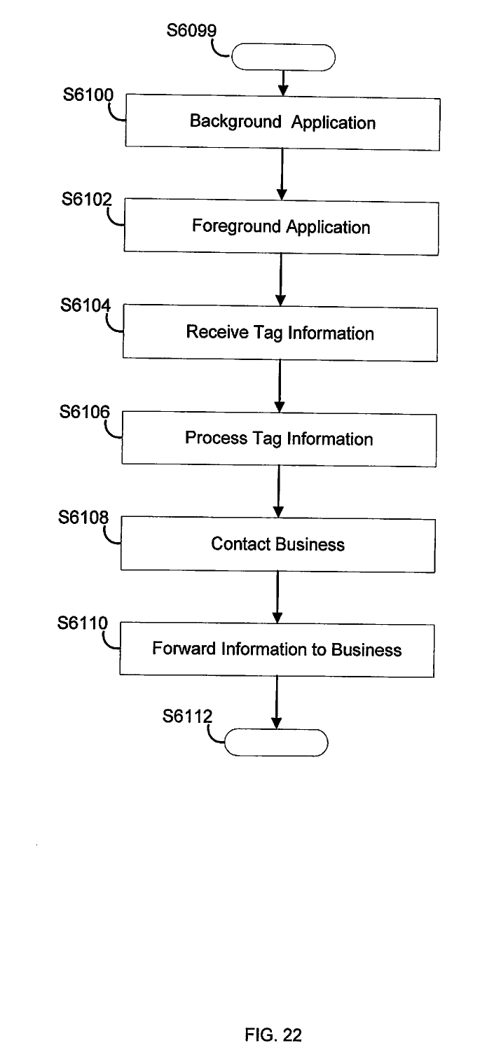

FIG. 22 depicts an exemplar process flow of a program on a MCD used in conjunction with a customer-business communication system, in for example, a deli counter at a store. In this aspect, along with the depiction in FIG. 22, the customer contacts the business server through the customer's MCD connection and identifies the queue by providing NFC tag information of the queue.

In segment S6100, a customer with a MCD and preferably having previously installed appropriate MCD contact software for the context of the business enters a business and proceeds to the deli section. The MCD contact software runs or is dormant in the background of the operating system. If the appropriate MCD contact software for the context, e.g., the business, is not installed, it will be automatically downloaded and installed when the MCD is placed near the NFC tag of the venue and the NFC provides instructions to the MCD to download and install the appropriate MCD contact software for the context. Process flow continues to segment S6102.

In segment S6102, the venue MCD contact software is activated either manually or automatically. Process flow continues to segment S6104.

In segment S6104, the MCD 100 is placed near a desired NFC tag 101. In this context, the NFC tag is preferably located at or near the site of the queue, e.g., at the deli counter. Through NFC communications between the MCD 100 and the NFC tag 101, the MCD 101 receives a NFC Tag packet of NFC tag 101. Process flow continues to segment S6106.

In segment S6106, the MCD contact software interprets the data contained in the first data field of the NFC Tag packet and determines the confirms the context and makes sure that the correct MCD contact software is executing. In this example, the MCD contact software identifies that the MCD is in the A&P supermarket and makes sure that the A&P supermarket business MCD contact software application is running. Process flow continues to segment S6108.

In segment S6108, using communication systems of the MCD, the MCD contact software contacts the business computer corresponding to the contact information of the first data field of the NFC Tag packet. Process flow continues to segment S6110.

In segment S6110, MCD contact software causes data to be sent to the business. The MCD contact software causes data from the second data field of the NFC Tag packet to be sent to the business. The MCD contact software also causes a MCD data packet to be sent to the business. Process flow continues to segment S6112.

In segment S6112, the MCD contact software returns to a standby status, either as a foreground or background process.

Thus, NFC tag information and MCD information has been sent to a business computer system 105 of a business 210.

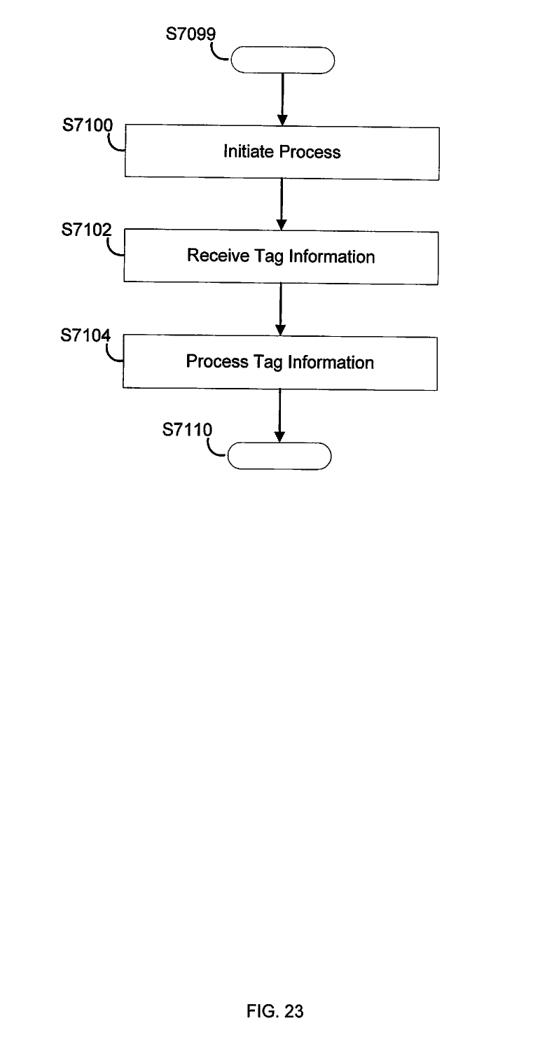

FIG. 23 depicts an exemplar process flow of a program on a business computer systems used in conjunction with a customer-business communication system.

In segment S7100, a business computer system 105 has installed business contact software and the software is executing. When the business contact software receives initial contact from a MCD running MCD contact software, process flow continues to segment S7102.

In segment S7102, the business contact software receives tag information from MCD contact software. The business contact software also receives a MCD data packet. Process flow continues to segment S7104.

In segment S7104, the business contact software examines the data of tag information. The business contact software uses the data to determine the which queue is being requested. If the business employs more than one queue, the business may use a look-up table to determine which queue is being requested for place on. The customer, by way of his MCD contact information, is entered into the queue Process flow continues to segment S7110.

In segment S7110, the business contact software continues to monitor communications for further communications from a MCD contact software.

Thus, a business contact software understands that this a request to be placed into a queue and receives NFC tag information, and customer information (MCD information) and places the customer in a queue.

The business computer system continuously maintains the queue and updates as necessary. When the business has completed processing a customer and the business is ready to service a new customer is, the business computer system will send a communication to the customer at the top, e.g., the next customer to be serviced, and update the queue appropriately. The business contacts the customer using the information in the data set pertaining to the customer.

In a variation, the customer can modify his place in the queue, preferably, lower in the queue. For example, an application on the mobile communication device informs the customer of his status in the queue. The customer can modify his position by a unit delay, where the unit delay is defined by the system and is a whole number. Thus, if the customers sees that he is close to being called (e.g., number 3 or less in the queue), but not conveniently located to the queue, or is currently occupied with something other than t equal, the customer can push back his place in the queue. The customer sends a signal to the computer system 101 indicating a request for a short delay. The computer system receives the request and updates the queue with the customer's position in the queue modified. Thus, if the customer's turn has or is nearing to come up but they are not done with what they are doing, the customer can select to move their placement in line without getting kicked out of line. Example, they are number 12 in line but 12 is coming up or has come up, the customer can interact with their NFC enabled device to remotely communicate back to the server informing the server that they need more time and would like to be placed in queue with three more people as a buffer so the system not moves that customer from place 12 in line to place 15, thereby giving the customer more time and allowing them to not lose their place in line.

By the MCD contact software communicating with the business contact software, the customer can request modifications to his place in the queue. Although general consideration would suggest that a customer would not be able to advance his position over other customers, as noted above a customer may request lowering his position in the queue. The MCD contact software can provide an option that communicates this request to the business contact software and also forwards MCD data and NFC tag data to the business contact software of the business computer system. The business computer system looks up the customer using the MCD data and the NFC data and if the request is acceptable, then the business computer system modifies the customer's place in the queue and modifies the rest of the queue accordingly.

In another aspect, a business' NFC reader collects contact information from a customer and forwards that information to it business computer system for processing.

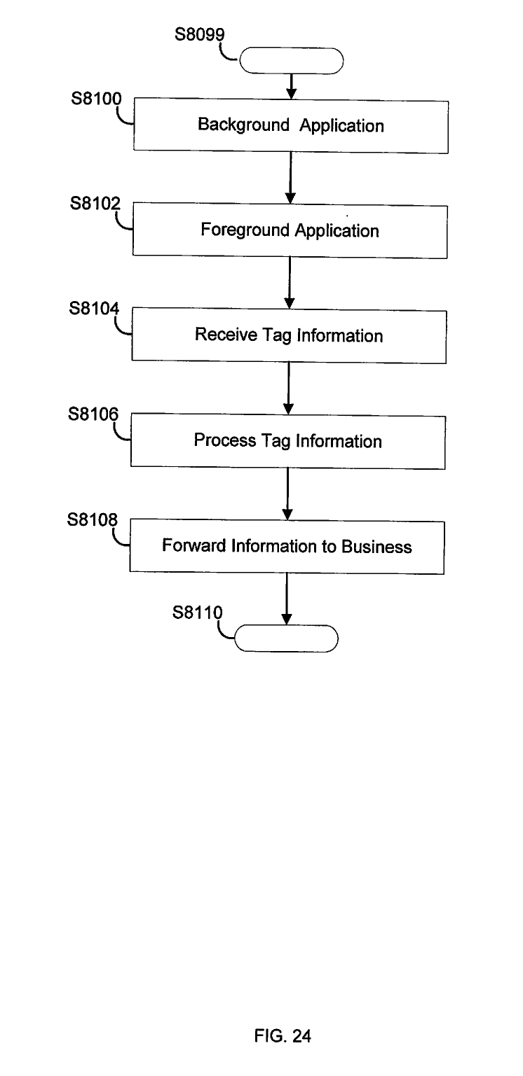

FIG. 24 depicts an exemplar process flow of a program on a MCD used in conjunction with a customer-business communication system, in for example, a deli counter at a store. In this aspect, along with the depiction in FIG. 24, the customer contacts the business'NFC reader through the customer's MCD connection and provides contact information to the NFC reader.

In segment S8100, a customer with a MCD and preferably having previously installed appropriate MCD contact software for the context of the business enters a business and proceeds to the deli section. The MCD contact software runs or is dormant in the background of the operating system. If the appropriate MCD contact software for the context, e.g., the business, is not installed, it will be automatically downloaded and installed when the MCD is placed near the NFC tag of the venue and the NFC provides instructions to the MCD to download and install the appropriate MCD contact software for the context. Process flow continues to segment S8102.

In segment S8102, the venue MCD contact software is activated either manually or automatically. Process flow continues to segment S8104.

In segment S8104, the MCD 100 is placed near a desired NFC tag 101. In this context, the NFC tag is preferably located at or near the site of the queue, e.g., at the deli counter. Through NFC communications between the MCD 100 and the NFC tag 101, the MCD 101 receives a NFC Tag packet of NFC tag 101. Process flow continues to segment S8106.

In segment S8106, the MCD contact software interprets the data contained in the first data field of the NFC Tag packet and determines the confirms the context and makes sure that the correct MCD contact software is executing. In this example, the MCD contact software identifies that the MCD is in the A&P supermarket and that this is a NFC reader scenario. Further, the MCD contact software makes sure that the A&P supermarket business MCD contact software application is running. Process flow continues to segment S8108.

In segment S8108, using communication systems of the MCD, the MCD contact software causes a MCD data packet to be sent to the business. Process flow continues to segment S8110.

In segment S8110, the MCD contact software returns to a standby status, either as a foreground or background process.

Thus, a customer's contact information, e.g., his MCD information, has been read by an NFC reader and thereby provided by to its business computer system 105 of a business 210.

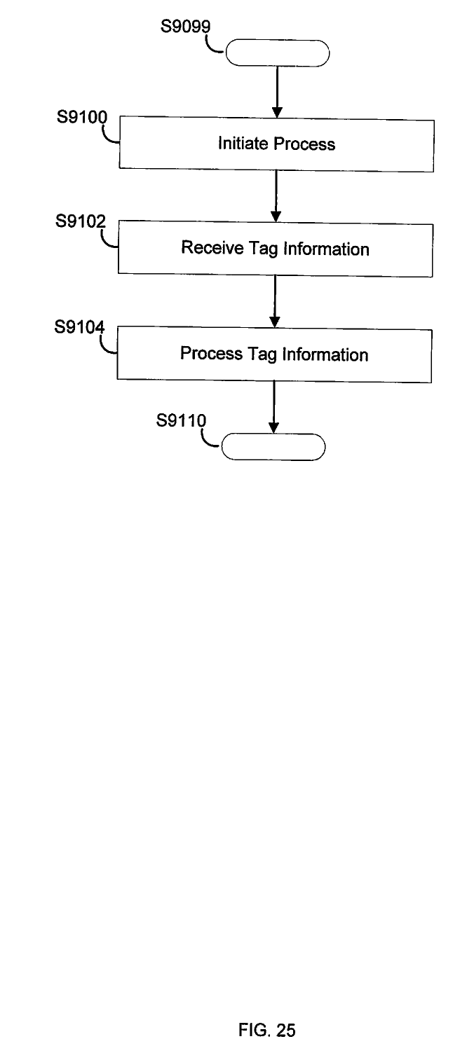

FIG. 25 depicts an exemplar process flow of a program on a business computer systems used in conjunction with a customer-business communication system, where a business computer system has received a customer's contact information through an NFC reader associated with the business.

In segment S9100, a business computer system 105 has installed business contact software and the software is executing. When the business contact software receives initial contact from a MCD running MCD contact software, process flow continues to segment S9102.

In segment S9102, the business computer system receives MCD data information from an associated NFC reader. Process flow continues to segment S9104.

In segment S9104, The business computer system identifies the NFC reader to be associated with a queue. If the business employs more than one queue, the business may use a look-up table to determine which queue is being requested for place on. The customer, by way of his MCD contact information, is entered into the queue Process flow continues to segment S9110.

In segment S9110, the business contact software continues to monitor communications for further communications from a MCD contact software or its associated NFC reader.

Thus, a business contact software understands that this a request to be placed into a queue and receives customer information (MCD information) and places the customer in a queue.

The business computer system continuously maintains the queue and updates as necessary. When the business has completed processing a customer and the business is ready to service a new customer is, the business computer system will send a communication to the customer at the top, e.g., the next customer to be serviced, and update the queue appropriately. The business contacts the customer using the information in the data set pertaining to the customer.

The description above refers to a mobile communication device capable of near field communications and a near field communication enabled mobile communication device, or the like, which is, but is not limited to, a mobile communication device that includes circuitry that enables the operation of near field communications, i.e., reading, writing, and card emulation.

In an aspect, the business contact software of business computer systems for the above applications are modified relatively easily, for example, the modifications can be made in short time, e.g., approximately 10 minutes. Furthermore, the MCD contact software can also be easily and quickly modified and downloaded to the MCD without much interference. As such, if the system is employed in a chain of stores, the system can be easily modified to be specific for each of the stores.

Additionally, although not necessarily expressly stated in the embodiments and aspects of the invention described above, a Smartlink system is intended to generally include a mobile communications device with a Smartlink module, or Smartlink module functionality, and a Smartlink server. In the preferred embodiments, the Smartlink server is a computer system which stores information of a customer and can communicate with the mobile communication device of the customer by cellular connection or other appropriate means. The Smartlink server can communicate with third party computer systems (e.g., of a seller or other third party) to exchange information and/or to provide and/or receive payment.

While the invention has been described and illustrated with reference to specific exemplary embodiments, it should be understood that many modifications and substitutions can be made without departing from the spirit and scope of the invention. For example, in a variation, a Smartphone, i.e., a iPhone, contains an app that is used to control reading information from a monitor tag, use that information to cause the iPhone to communicate with the appropriate institutional server, and subsequently use the app on the iPhone to control the content display on the monitor. Furthermore, although the application refers to near field communications, the invention is not intended as being limited to only NFC communications and is intended to include NFC communications as well as any other short distance communications, where the distances are typically less than one (1) meter. Furthermore, although it may not explicitly set out above, different aspects of the inventions described above can be combined to reflect an embodiment of the inventions. Furthermore, although many of the aspects above describe the having the MCD contact software installed before starting operations, however, the invention is not so limited. For example, as also noted above, if the appropriate MCD contact software required for a context is not installed, it is relatively straightforward to download and install, thus, for all intents and purposes, the aspects are described assuming that the software has already been installed. Furthermore, although referred to a customer requesting service, service is to be interpreted broadly and can refer to any reasonably type of service that a customer may request. For example, service may include, but is not limited to, providing data, providing customer service, providing an employee to physically respond to a location where is a customer is located, providing an employee to communicate with the customer, placing a request for service (e.g., being placed in a queue for service), modifying a request for service, requesting the purchase of an item(s), requesting the selection of an item, and bidding on an item. Although the invention described above discloses disclosing, communicating, forwarding, sharing, etc, data or information or the like, the invention is not so limited. Representations of the data or information or the like are considered to be the same. For example, data in a NFC tag may be stored as “1234;” however, a representation of that number is the same and has the same effect.

Accordingly, the invention is not to be considered as limited by the foregoing description but is only limited by the scope of the claims.

What is claimed as new and desired to be protected by Letters Patent of the United States is:

1. A method for providing a customer an ability to request an item from a closest business location, comprising:
receiving by a business computer system from a customer in a venue a request for service of an item from a business in said venue;
determining by said business computer system a location of said customer; and
determining by said business computer system location of said business in said venue closest to the location of the customer.

2. The method of claim 1, further comprising:
forwarding the request for service to the closest located business.

3. The method of claim of claim 2, wherein said determination of location further comprises:
determining locations of said business within said venue; and
determining which of said locations of said business within said venue is closest to said customer.

4. The method of claim 3, wherein said determining which of said locations of said business within said venue is closest to said customer further comprises:
using a lookup table to determine which of said locations of said business within said venue is closest to said customer.

5. The method of claim 2, where said determining said location of said customer further comprises:
receiving location data corresponding to said location of said customer.

6. The method of claim 5, where said receiving location data corresponding to said location of said customer further comprises:
receiving tag data representing a location of said customer.

7. The method of claim 5, further comprising:
receiving contact information for said customer.

8. The method of claim 6, further comprising:
causing a message to be sent to said customer indicating that the customer's request for service has been received, wherein said causing said message to be sent uses contact information of said customer.

9. The method of claim 6, further comprising:
causing a message to be sent to said customer indicating that the customer's request for service has been completed, wherein said causing said message to be sent uses contact information of said customer.

10. The method of claim 9, further comprising:
receiving payment confirmation corresponding to said request for service.

11. A method for providing a customer an ability to request service based on a location of the customer, comprising:
receiving by a business computer system from a customer in a business a request for service;
receiving location data of said customer by said business computer system;
determining by said business computer system a location of said customer based on said location data; and
determining by said business computer system a type of service requested by said customer.

12. The method of claim 11, where said receiving location data of said customer further comprises:
receiving tag data representing a location of said customer.

13. The method of claim 11, further comprising:
if said determined type of service corresponds to having an employee respond to the location of customer then:
determining an employee that corresponds to the location of customer.

14. The method of claim 13, further comprising:
determining contact information of said employee.

15. The method of claim 14, further comprising:
sending a message to said employee using contact information of said employee.

16. The method of claim 15, further comprising:
receiving a message indicating that employee has made contact with said customer, where said message includes at least some of said customer's contact information, where said customer's contact information was received through near field communications by employee's MCD.

17. The method of claim 15, further comprising:
receiving a message indicating that employee has completed service request of said customer.

18. The method of claim 13, further comprising:
determining if said employee is available, if said employee is not available, the determining a contingent employee that corresponds to the location of said customer.

19. The method of claim 18, further comprising:
determining if said contingent employee is available, if said employee is not available, the determining a second contingent employee that corresponds to the location of said customer.

20. A method for using a near field communication device to contact service personnel, comprising:
reading by a near field communication enabled device information associated with a service; and
using said information about said product to order said product for purchase or information about the service to order the service or provide additional information using said near field communication device.
